(19) United States
(12) Patent Application Publication
(10) Pub. No.: US 2013/0171502 A1
(43) Pub. Date: Jul. 4, 2013

(54) Hybrid electrode and surface-mediated cell-based super-hybrid energy storage device containing same

(71) Applicants: Guorong Chen, Fairborn, OH (US); Aruna Zhamu, Centerville, OH (US); Xiqing Wang, Cincinnati, OH (US); Bor Z. Jang, Centerville, OH (US); Yanbo Wang, Fairborn, OH (US)

(72) Inventors: Guorong Chen, Fairborn, OH (US); Aruna Zhamu, Centerville, OH (US); Xiqing Wang, Cincinnati, OH (US); Bor Z. Jang, Centerville, OH (US); Yanbo Wang, Fairborn, OH (US)

(21) Appl. No.: 13/374,408

(22) Filed: Dec. 29, 2011

(51) Int. Cl. H01M 4/13; H01G 9/155; H01G 9/035; H01M 10/26; H01M 10/02; B82Y 99/00

(52) U.S. Cl. 429/149; 429/209; 429/231.8; 429/218.1; 429/221; 429/222; 429/223; 429/224; 429/225; 429/229; 429/231.1; 429/231.5; 429/213; 429/206; 429/300; 361/502; 361/505; 977/948

(57) ABSTRACT

The present invention provides a multi-component hybrid electrode for use in an electrochemical super-hybrid energy storage device. The hybrid electrode contains at least a current collector, at least an intercalation electrode active material storing lithium inside interior or bulk thereof, and at least an intercalation-free electrode active material having a specific surface area no less than 100 m²/g and storing lithium on a surface thereof, wherein the intercalation electrode active material and the intercalation-free electrode active material are in electronic contact with the current collector. The resulting super-hybrid cell exhibits exceptional high power and high energy density, and long-term cycling stability that cannot be achieved with conventional supercapacitors, lithium-ion capacitors, lithium-ion batteries, and lithium metal secondary batteries.

This invention is based on the research results of a project sponsored by the US National Science Foundation SBIR-STTR Program.

### FIELD OF THE INVENTION

This invention relates generally to the field of electrochemical energy storage devices and, more particularly, to a totally new hybrid electrode (the electrode itself being a hybrid) and a super-hybrid cell that contains this hybrid electrode. The intercalation-free active material of this hybrid electrode enables a charge/discharge behavior characteristic of a surface-mediated cell (SMC). The super-hybrid cell operates primarily on the exchange of lithium ions between anode surfaces and cathode surfaces, plus some amount of lithium being exchanged between interior of an electrode and surfaces/interior of an opposing electrode.

### BACKGROUND OF THE INVENTION

### Supercapacitors (Ultra-Capacitors or Electro-Chemical Capacitors):

Supercapacitors are being considered for electric vehicle (EV), renewable energy storage, and modern grid applications. The high volumetric capacitance density of a supercapacitor derives from using porous electrodes to create a large surface area conducive to the formation of diffuse electric double layer (EDL) charges. The ionic species (cations and anions) in the EDL are formed in the electrolyte near an electrode surface (but not on the electrode surface per se) when voltage is imposed upon a symmetric supercapacitor (or EDLC), as schematically illustrated in FIG. 1(A). The required ions for this EDL mechanism pre-exist in the liquid electrolyte (randomly distributed in the electrolyte) when the cell is made or in a discharged state (FIG. 1(B)). These ions do not come from the opposite electrode material. In other words, the required ions to be formed into an EDL near the surface of a negative electrode (anode) active material (e.g., activated carbon particle) do not come from the positive electrode (cathode); i.e., they are not previously captured or stored in the surfaces or interiors of a cathode active material. Similarly, the required ions to be formed into an EDL near the surface of a cathode active material do not come from the surface or interior of an anode active material.

When the supercapacitor is re-charged, the ions (both cations and anions) already pre-existing in the liquid electrolyte are formed into EDLs near their respective local electrodes. There is no exchange of ions between an anode active material and a cathode active material. The amount of charges that can be stored (capacitance) is dictated solely by the concentrations of cations and anions that pre-exist in the electrolyte. These concentrations are typically very low and are limited by the solubility of a salt in a solvent, resulting in a low energy density.

In some supercapacitors, the stored energy is further augmented by pseudo-capacitance effects due to some electrochemical reactions (e.g., redox). In such a pseudo-capacitor, the ions involved in a redox pair also pre-exist in the electrolyte. Again, there is no exchange of ions between an anode active material and a cathode active material.

Since the formation of EDLs does not involve a chemical reaction or an exchange of ions between the two opposite electrodes, the charge or discharge process of an EDL supercapacitor can be very fast, typically in seconds, resulting in a very high power density (more typically 3,000-8,000 W/Kg). Compared with batteries, supercapacitors offer a higher power density, require no maintenance, offer a much higher cycle-life, require a very simple charging circuit, and are generally much safer. Physical, rather than chemical, energy storage is the key reason for their safe operation and extraordinarily high cycle-life.

Despite the positive attributes of supercapacitors, there are several technological barriers to widespread implementation of supercapacitors for various industrial applications. For instance, supercapacitors possess very low energy densities when compared to batteries (e.g., 5-8 Wh/kg for commercial supercapacitors vs. 20-30 Wh/Kg for the lead acid battery and 50-100 Wh/kg for the NiMH battery). Lithium-ion batteries possess a much higher energy density, typically in the range of 100-180 Wh/kg, based on the total cell weight.

### Lithium-Ion Batteries (LIB):

Although possessing a much higher energy density, lithium-ion batteries deliver a very low power density (typically 100-500 W/Kg), requiring typically hours for re-charge. Conventional lithium-ion batteries also pose some safety concern.

The low power density or long re-charge time of a lithium ion battery is due to the mechanism of shuttling lithium ions between the interior of an anode and the interior of a cathode, which requires lithium ions to enter or intercalate into the bulk of anode active material particles during re-charge, and into the bulk of cathode active material particles during discharge. For instance, as illustrated in FIG. 1(C), in a most commonly used lithium-ion battery featuring graphite particles as an anode active material, lithium ions are required to diffuse into the inter-planar spaces of a graphite crystal at the anode during re-charge. Most of these lithium ions have to come all the way from the cathode side by diffusing out of the bulk of a cathode active particle, through the pores of a solid separator (pores being filled with a liquid electrolyte), and into the bulk of a graphite particle at the anode.

During discharge, lithium ions diffuse out of the anode active material (e.g. de-intercalate out of graphite particles 10 μm in diameter), migrate through the liquid electrolyte phase, and then diffuse into the bulk of complex cathode crystals (e.g. intercalate into particles lithium cobalt oxide, lithium iron phosphate, or other lithium insertion compound), as illustrated in FIG. 1(D). Because liquid electrolyte only reaches the external surface (not interior) of a solid particle (e.g. graphite particle), lithium ions swimming in the liquid electrolyte can only migrate (via fast liquid-state diffusion) to the surface of a graphite particle. To penetrate into the bulk of a solid graphite particle would require a slow solid-state diffusion (commonly referred to as “intercalation”) of lithium ions. The diffusion coefficients of lithium in solid particles of lithium metal oxide are typically 10⁻¹⁶-10⁻⁸ cm²/sec (more typically 10⁻¹⁴-10⁻¹⁰ cm²/sec), and those of lithium in liquid are approximately 10⁻⁶ cm²/sec.

In other words, these intercalation or solid-state diffusion processes require a long time to accomplish because solid-state diffusion (or diffusion inside a solid) is difficult and slow. This is why, for instance, the current lithium-ion battery for plug-in hybrid vehicles requires 2-7 hours of recharge time, as opposed to just seconds for supercapacitors. The above discussion suggests that an energy storage device that is capable of storing as much energy as in a battery and yet can be fully recharged in one or two minutes like a supercapacitor would be considered a revolutionary advancement in energy storage technology.

### Lithium Ion Capacitors (LIC):

A hybrid energy storage cell that is developed for the purpose of combining some features of an EDL or symmetric supercapacitor and those of a lithium-ion battery (LIB) is a lithium-ion capacitor (LIC). A LIC contains a lithium intercalation compound (e.g., graphite particles) as an anode and an EDL capacitor-type cathode (e.g. activated carbon, AC), as schematically illustrated in FIG. 1(E). In a commonly used LIC, LiPF₆ is used as an electrolyte salt, which is dissolved in a solvent, such as propylene carbonate. When the LIC is in a charged state, lithium ions are retained in the interior of the lithium intercalation compound anode (usually micron-scaled graphite particles) and their counter-ions (e.g. negatively charged PF₆⁻) are disposed near activated carbon surfaces (but not on an AC surface, nor captured by an AC surface), as illustrated in FIG. 1(E).

When the LIC is discharged, lithium ions migrate out from the interior of graphite particles (a slow solid-state diffusion process) to enter the electrolyte phase and, concurrently, the counter-ions PF₆⁻ are also released from the EDL zone, moving further away from AC surfaces into the bulk of the electrolyte. In other words, both the cations (Li⁺ ions) and the anions (PF₆⁻) are randomly disposed in the liquid electrolyte, not associated with any electrode (FIG. 1(F)). This implies that, just like in a symmetric supercapacitor, the amounts of both the cations and the anions that dictate the specific capacitance of a LIC are essentially limited by the solubility limit of the lithium salt in a solvent (i.e. limited by the amount of LiPF₆ that can be dissolved in the solvent). Therefore, the energy density of LICs (a maximum of 14 Wh/kg) is not much higher than that (6 Wh/kg) of an EDLC (symmetric supercapacitor), and remains an order of magnitude lower than that (most typically 120-150 Wh/kg) of a LIB.

Furthermore, due to the need to undergo de-intercalation and intercalation at the anode, the power density of a LIC is not high (typically <10 kW/kg, which is comparable to or only slightly higher than those of an EDLC).

Recently, chemically treated multi-walled carbon nano-tubes (CNTs) containing carbonyl groups were used by Lee, et al as a cathode active material for a LIC containing lithium titanate as the anode material [S. W. Lee, et al, “High Power Lithium Batteries from Functionalized Carbon Nanotubes,” Nature Nanotechnology, 5 (2010) 531-537]. This is another type of hybrid battery/supercapacitor device or lithium-ion capacitor. In addition, in a half-cell configuration discussed in the same report, lithium foil was used by Lee, et al as the anode and functionalized CNTs as the cathode, providing a relatively high power density. However, the CNT-based electrodes prepared by the layer-by-layer (LBL) approach suffer from several technical issues beyond just the high costs. Some of these issues are:
(1) CNTs contain a significant amount of impurity, particularly those transition metal or noble metal particles used as a catalyst required of a chemical vapor deposition process. These catalytic materials are highly undesirable in a battery electrode due to their high propensity to cause harmful reactions with electrolyte.
(2) CNTs tend to form a tangled mass resembling a hairball, which is difficult to work with during electrode fabrication (e.g., difficult to disperse in a liquid solvent or resin matrix).
(3) The so-called “layer-by-layer” approach (LBL) used by Lee, et al is a slow and expensive process that is not amenable to large-scale fabrication of battery electrodes, or mass production of electrodes with an adequate thickness. Most of the batteries have an electrode thickness of 100-300 μm, but the thickness of the LBL electrodes produced by Lee, et al was limited to 3 μm or less.
(4) CNTs have very limited amounts of suitable sites to accept a functional group without damaging the basal plane structure. A CNT has only one end that is readily functionalizable and this end is an extremely small proportion of the total CNT surface. By chemically functionalizing the exterior basal plane, one could dramatically compromise the electronic conductivity of a CNT.

### More Recent Developments:

Most recently, our research group has invented a revolutionary class of high-power and high-energy-density energy storage devices now commonly referred to as the surface-mediated cell (SMC). This has been reported in the following patent applications and a scientific paper:
1. C. G. Liu, et al., “Lithium Super-battery with a Functionalized Nano Graphene Cathode,” U.S. patent application Ser. No. 12/806,679 (Aug. 19, 2010).
2. C. G. Liu, et al, “Lithium Super-battery with a Functionalized Disordered Carbon Cathode,” U.S. patent application Ser. No. 12/924,211 (Sep. 23, 2010).
3. Aruna Zhamu, C. G. Liu, David Neff, and Bor Z. Jang, “Surface-Controlled Lithium Ion-Exchanging Energy Storage Device,” U.S. patent application Ser. No. 12/928,927 (Dec. 23, 2010).
4. Aruna Zhamu, C. G. Liu, David Neff, Z. Yu, and Bor Z. Jang, “Partially and Fully Surface-Enabled Metal Ion-Exchanging Battery Device,” U.S. patent application Ser. No. 12/930,294 (Jan. 3, 2011).
5. Aruna Zhamu, Chen-guang Liu, and Bor Z. Jang, “Partially Surface-Mediated Lithium Ion-Exchanging Cells and Method of Operating Same,” U.S. patent application Ser. No. 13/199,713 (Sep. 7, 2011).
6. Bor Z. Jang, C. G. Liu, D. Neff, Z. Yu, Ming C. Wang, W. Xiong, and A. Zhamu, “Graphene Surface-Enabled Lithium Ion-Exchanging Cells: Next-Generation High-Power Energy Storage Devices,” Nano Letters, 2011, 11 (9), pp 3785-3791.
   There are two types of SMCs: partially surface-mediated cells (p-SMC, also referred to as lithium super-batteries) and fully surface-mediated cells (f-SMC). Both types of SMCs have the following components:
   (a) An anode containing an anode current collector, such as copper foil (in a lithium super-battery or p-SMC), or an anode current collector plus an anode active material (in an f-SMC). The anode active material is preferably a nano-carbon material (e.g., graphene) having a high specific surface area (preferably >100 m²/g, more preferably >500 m²/g, further preferably >1,000 m²/g, and most preferably >1,500 m²/g);
   (b) A cathode containing a cathode current collector and a cathode active material (e.g. graphene or disordered carbon) having a high specific surface area (preferably >100 m²/g, more preferably >500 m²/g, further preferably >1,000 m²/g, still more preferably >1,500 m²/g, and most preferably >2,000 m²/g);
   (c) A porous separator separating the anode and the cathode, soaked with an electrolyte (preferably liquid or gel electrolyte); and
   (d) A lithium source disposed in an anode or a cathode (or both) and in direct contact with the electrolyte.

In a fully surface-mediated cell, f-SMC, as illustrated in FIG. 2, both the cathode active material and the anode active material are porous, having large amounts of graphene surfaces in direct contact with liquid electrolyte. These electrolyte-wetted surfaces are ready to interact with nearby lithium ions dissolved therein, enabling fast and direct adsorption of lithium ions on graphene surfaces and/or redox reaction between lithium ions and surface functional groups, thereby removing the need for solid-state diffusion or intercalation. These materials storing lithium on surfaces are referred to as an intercalation-free material.

When the SMC cell is made, particles or foil of lithium metal are implemented at the anode (FIG. 2A), which are ionized during the first discharge cycle, supplying a large amount of lithium ions. These ions migrate to the nano-structured cathode through liquid electrolyte, entering the pores and reaching the surfaces in the interior of the cathode without having to undergo solid-state intercalation (FIG. 2B). When the cell is re-charged, a massive flux of lithium ions are quickly released from the large amounts of cathode surfaces, migrating into the anode zone. The large surface areas of the nano-structured anode enable concurrent and high-rate deposition of lithium ions (FIG. 2C), re-establishing an electrochemical potential difference between the lithium-decorated anode and the cathode.

A particularly useful nano-structured electrode material is nano graphene platelet (NGP), which refers to either a single-layer graphene sheet or multi-layer graphene pletelets. A single-layer graphene sheet is a 2-D hexagon lattice of carbon atoms covalently bonded along two plane directions. We have studied a broad array of graphene materials for electrode uses: pristine graphene, graphene oxide, chemically or thermaly reduced graphene, graphene fluoride, chemically modified graphene, hydrogenated graphene, nitrogenated graphene, doped graphene. In all cases, both single-layer and multi-layer graphene were prepared from natural graphite, petroleum pitch-derived artificial graphite, micron-scaled graphite fibers, activated carbon (AC), and treated carbon black (t-CB). AC and CB contain narrower graphene sheets or aromatic rings as a building block, while graphite and graphite fibers contain wider graphene sheets. Their micro-structures all have to be exfoliated (to increase inter-graphene spacing in graphite) or activated (to open up nano gates or pores in t-CB) to allow liquid electrolyte to access more graphene edges and surfaces where lithium can be captured. Other types of disordered carbon studied have included soft carbon (including meso-phase carbon, such as meso-carbon micro-beads), hard carbon (including petroleum coke), and amorphous carbon, in addition to carbon black and activated carbon. All these carbon/graphite materials have graphene sheets dispersed in their microstructure.

These highly conducting materials, when used as a cathode active material, can have a functional group that is capable of rapidly and reversibly forming a redox reaction with lithium ions. This is one possible way of capturing and storing lithium directly on a graphene surface (including edge). We have also discovered that the benzene ring centers of graphene sheets are highly effective and stable sites for capturing and storing lithium atoms, even in the absence of a lithium-capturing functional group.

Similarly, in a lithium super-battery (p-SMC), the cathode includes a chemically functionalized NGP or a functionalized disordered carbon material having certain specific functional groups capable of reversibly and rapidly forming/releasing a redox pair with a lithium ion during the discharge and charge cycles of a p-SMC. In a p-SMC, the disordered carbon or NGP is used in the cathode (not the anode) of the lithium super-battery. In this cathode, lithium ions in the liquid electrolyte only have to migrate to the edges or surfaces of graphene sheets (in the case of functionalized NGP cathode), or the edges/surfaces of the aromatic ring structures (small graphene sheets) in a disordered carbon matrix. No solid-state diffusion is required at the cathode. The presence of a functionalized graphene or carbon having functional groups thereon enables reversible storage of lithium on the surfaces (including edges), not the bulk, of the cathode material. Such a cathode material provides one type of lithium-storing or lithium-capturing surface. Again, another possible mechanism is based on the benzene ring centers of graphene sheets that are highly effective and stable sites for capturing and storing lithium atoms.

In a lithium super-battery or p-SMC, the anode comprises a current collector and a lithium foil alone (as a lithium source), without an anode active material to support or capture lithium ions/atoms. Lithium has to deposit onto the front surface of an anode current collector alone (e.g. copper foil) when the battery is re-charged. Since the specific surface area of a current collector is very low (typically <1 m²/gram), the over-all lithium re-deposition rate can be relatively low as compared to f-SMC.

The features and advantages of SMCs that differentiate the SMC from conventional lithium-ion batteries (LIB), supercapacitors, and lithium-ion capacitors (LIC) are summarized below:
(A) In an SMC, lithium ions are exchanged between anode surfaces and cathode surfaces, not bulk or interior:
   a. The conventional LIB stores lithium in the interior of an anode active material (e.g. graphite particles) in a charged state (e.g. FIG. 1(C)) and the interior of a cathode active material in a discharged state (FIG. 1(D)). During the discharge and charge cycles of a LIB, lithium ions must diffuse into and out of the bulk of a cathode active material, such as lithium cobalt oxide (LiCoO₂) and lithium iron phosphate (LiFePO₄). Lithium ions must also diffuse in and out of the inter-planar spaces in a graphite crystal serving as an anode active material. The lithium insertion or extraction procedures at both the cathode and the anode are very slow, resulting in a low power density and requiring a long re-charge time.
   b. When in a charged state, a LIC also stores lithium in the interior of graphite anode particles (FIG. 1(E)), thus requiring a long re-charge time as well. During discharge, lithium ions must also diffuse out of the interior of graphite particles, thereby compromising the power density. The lithium ions (cations Li⁺) and their counter-ions (e.g. anions PF₆⁻) are randomly dispersed in the liquid electrolyte when the LIC is in a discharged state (FIG. 1(F)). In contrast, the lithium ions are captured by graphene surfaces (e.g. at centers of benzene rings of a graphene sheet as illustrated in FIG. 2(D)) when an SMC is in a discharged state. Lithium is deposited on the surface of an anode (anode current collector and/or anode active material) when the SMC is in a charged state. Relatively few lithium ions stay in the liquid electrolyte.
   c. When in a charged state, a symmetric supercapacitor (EDLC) stores their cations near a surface (but not at the surface) of an anode active material (e.g. activated carbon, AC) and stores their counter-ions near a surface (but not at the surface) of a cathode active material (e.g., AC), as illustrated in FIG. 1(A). When the EDLC is discharged, both the cations and their counter-ions are re-dispersed randomly in the liquid electrolyte, further away from the AC surfaces (FIG. 1(B)). In other words, neither the cations nor the anions are exchanged between the anode surface and the cathode surface.
   d. For a supercapacitor exhibiting a pseudo-capacitance or redox effect, either the cation or the anion form a redox pair with an electrode active material (e.g. polyanniline or manganese oxide coated on AC surfaces) when the supercapacitor is in a charged state. However, when the supercapacitor is discharged, both the cations and their counter-ions are re-dispersed randomly in the liquid electrolyte, away from the AC surfaces. Neither the cations nor the anions are exchanged between the anode surface and the cathode surface. In contrast, the cations (Li⁺) are captured by cathode surfaces (e.g. graphene benzene ring centers) when the SMC is in the discharged state. It is also the cations (Li⁺) that are captured by surfaces of an anode current collector and/or anode active material) when the SMC is in the discharged state. The lithium ions are exchanged between the anode and the cathode.
   e. An SMC operates on the exchange of lithium ions between the surfaces of an anode (anode current collector and/or anode active material) and a cathode (cathode active material). The cathode in a SMC has (a) benzene ring centers on a graphene plane to capture and release lithium; (b) functional groups (e.g. attached at the edge or basal plane surfaces of a graphene sheet) that readily and reversibly form a redox reaction with a lithium ion from a lithium-containing electrolyte; and (c) surface defects to trap and release lithium during discharge and charge. Unless the cathode active material (e.g. graphene, CNT, or disordered carbon) is heavily functionalized, mechanism (b) does not significantly contribute to the lithium storage capacity.
      When the SMC is discharged, lithium ions are released from the surfaces of an anode (surfaces of an anode current collector and/or surfaces of an anode active material, such as graphene). These lithium ions do not get randomly dispersed in the electrolyte. Instead, these lithium ions swim through liquid electrolyte and get captured by the surfaces of a cathode active material. These lithium ions are stored at the benzene ring centers, trapped at surface defects, or captured by surface/edge-borne functional groups. Very few lithium ions remain in the liquid electrolyte phase.
      When the SMC is re-charged, massive lithium ions are released from the surfaces of a cathode active material having a high specific surface area. Under the influence of an electric field generated by an outside battery charger, lithium ions are driven to swim through liquid electrolyte and get captured by anode surfaces, or are simply electrochemically plated onto anode surfaces.
(B) In a discharged state of a SMC, a great amount of lithium atoms are captured on the massive surfaces of a cathode active material. These lithium ions in a discharged SMC are not dispersed or dissolved in the liquid electrolyte, and not part of the electrolyte. Therefore, the solubility limit of lithium ions and/or their counter-ions does not become a limiting factor for the amount of lithium that can be captured at the cathode side. It is the specific surface area at the cathode that dictates the lithium storage capacity of an SMC provided there is a correspondingly large amount of available lithium atoms at the lithium source prior to the first discharge/charge.
(C) During the discharge of an SMC, lithium ions coming from the anode side through a separator only have to diffuse in the liquid electrolyte residing in the cathode to reach a surface/edge of a graphene plane. These lithium ions do not need to diffuse into or out of the volume (interior) of a solid particle. Since no diffusion-limited intercalation is involved at the cathode, this process is fast and can occur in seconds. Hence, this is a totally new class of energy storage device that exhibits unparalleled and unprecedented combined performance of an exceptional power density, high energy density, long and stable cycle life, and wide operating temperature range. This device has exceeded the best of both battery and supercapacitor worlds.
(D) In an f-SMC, the energy storage device operates on lithium ion exchange between the cathode and the anode. Both the cathode and the anode (not just the cathode) have a lithium-capturing or lithium-storing surface and both electrodes (not just the cathode) obviate the need to engage in solid-state diffusion. Both the anode and the cathode have large amounts of surface areas to allow lithium ions to deposit thereon simultaneously, enabling dramatically higher charge and discharge rates and higher power densities.
   The uniform dispersion of these surfaces of a nano-structured material (e.g. graphene, CNT, disordered carbon, nano-wire, and nano-fiber) at the anode also provides a more uniform electric field in the electrode in which lithium can more uniformly deposit without forming a dendrite. Such a nano-structure eliminates the potential formation of dendrites, which was the most serious problem in conventional lithium metal batteries (commonly used in 1980s and early 1990s before being replaced by lithium-ion batteries).
(E) A SMC typically has an open-circuit voltage of >1.0 volts (most typically >1.5 volts) and can operate up to 4.5 volts for lithium salt-based organic electrolyte. Using an identical electrolyte, an EDLC or symmetric supercapacitor has an open-circuit voltage of essentially 0 volts and can only operate up to 2.7 volts. Also using an identical electrolyte, a LIC operates between 2.2 volts and 3.8 volts. These are additional manifestations of the notion that the SMC is fundamentally different and patently distinct from both an EDLC and a LIC.

The amount of lithium stored in the lithium source when a SMC is made dictates the amount of lithium ions that can be exchanged between an anode and a cathode. This, in turn, dictates the energy density of the SMC.

In all of the aforementioned electrochemical energy storage devices (supercapacitor, LIB, LIC, p-SMC, f-SMC, and other lithium metal cells, such as lithium-sulfur cell and lithium-air cell), every individual electrode is a single-functional electrode. For instance, the anode in a LIB or LIC is an intercalation compound (e.g. graphite or lithium titanate particles) that stores lithium in the interior or bulk of the compound and the lithium in-take and release depends upon intercalation and de-intercalation of lithium (solid-state diffusion). The cathode (e.g. lithium iron phosphate or lithium cobalt oxide) is also an intercalation compound that stores lithium in the interior of a cathode particle. This type of electrode is herein referred to as an “intercalation electrode active material” or simply “intercalation material.”

In contrast, the cathode active material in a p-SMC or f-SMC (e.g. graphene) operates by capturing and storing lithium atoms on graphene surfaces, requiring no intercalation or de-intercalation. This type of material is herein referred to as an “intercalation-free electrode active material” or “intercalation-free material.”

Every individual electrode (anode or cathode) in all of the known electrochemical energy storage devices is either an intercalation type or an intercalation-free type, but not both. During the course of our investigation on SMC cells, we have discovered a new type of electrode that is herein referred to as a hybrid electrode. A hybrid electrode is composed of at least one intercalation electrode active material and one intercalation-free electrode active material that co-exist in the same electrode, e.g. an interaction material coated on one surface of a current collector and an intercalation-free material coated on an opposing surface of the same current collector. Such a hybrid electrode, when used as an anode and/or as a cathode of an energy storage device, imparts many unique, novel, and unexpected effect to the device.

### SUMMARY OF THE INVENTION

The present invention provides a multi-component hybrid electrode for use in an electrochemical super-hybrid energy storage device. The electrode itself is a hybrid electrode, not just the energy storage device.

The hybrid electrode contains at least a current collector, at least an intercalation electrode active material storing lithium inside interior or bulk thereof, and at least an intercalation-free electrode active material having a specific surface area no less than 100 m²/g and storing lithium on a surface thereof, wherein the intercalation electrode active material and the intercalation-free electrode active material are in electronic contact with the current collector.

The “intercalation electrode active material” refers to an electrode material that stores lithium in the interior or bulk of the compound. For instance, graphite or lithium titanate particles commonly used in a LIB or LIC are intercalation compounds that store lithium in the interior or bulk of the compound. The insertion and release of lithium normally occur through lithium solid-state diffusion procedures called “intercalation” and “de-intercalation,” respectively. Commonly used cathode active materials in a LIB (e.g. lithium iron phosphate and lithium cobalt oxide) are also intercalation compounds that store lithium in the interior of a cathode particle. Any of these electrode active materials may be selected as an intercalation electrode active material for use in the presently disclosed hybrid electrode. Graphite and carbon-based intercalation compounds, particularly those used in an anode of a LIB, normally have a specific surface area less than 100 m²/g, more typically less than 50 m²/g, and most typically less than 10 m²/g. The LIB industry prefers to use an anode active material less than 3 m²/g due to the concern that a higher specific surface area tends to form a greater amount of solid-electrolyte interphase (SEI) at the anode, irreversibly consuming more lithium. SEI is a highly undesirable feature in a LIB since it is a primary source of capacity irreversibility.

In contrast, the cathode active material in a p-SMC or f-SMC (e.g. graphene) operates by capturing and storing lithium atoms on graphene surfaces, requiring no intercalation or de-intercalation. This type of material is herein referred to as an “intercalation-free electrode active material.”

In a preferred embodiment, the intercalation electrode active material and the intercalation-free electrode active material in a multi-component hybrid electrode form two separate discrete layers that are respectively bonded to two opposing surfaces of the current collector to form a laminated three-layer electrode. Alternatively, they can form two layers stacked together having one layer bonded to a surface of the current collector to form a laminated electrode. Further alternatively, the intercalation electrode active material and the intercalation-free electrode active material may be mixed to form a hybrid active material coated onto one surface or two opposing surfaces of the current collector. Preferably, the current collector is porous to enable passage of lithium ions.

In a desired embodiment, the multi-component hybrid electrode can have at least two current collectors internally connected in parallel, wherein the intercalation electrode active material is coated on at least a surface of a first current collector and the intercalation-free electrode active material is coated on at least a surface of a second current collector.

Preferably, the hybrid electrode is pre-lithiated, having lithium inserted into interior of the intercalation electrode active material and/or having lithium deposited on a surface of the intercalation-free electrode active material before or when the device is made.

It is desirable to have an intercalation electrode active material having a specific surface area less than 100 m²/g. Further desirably, the intercalation electrode active material has a specific surface area less than 100 m²/g and the intercalation-free electrode active material has a specific surface area no less than 500 m²/g. Most desirably, the intercalation electrode active material has a specific surface area less than 50 m²/g and the intercalation-free electrode active material has a specific surface area no less than 1,500 m²/g.

In one possible super-hybrid energy storage device, the hybrid electrode is an anode and the constituent intercalation material is an anode active material selected from the following:
(a) a graphite or carbonaceous intercalation compound having a specific surface area less than 100 m²/g when formed into an anode (the intercalation compound may be selected from natural graphite, synthetic graphite, meso-phase carbon, soft carbon, hard carbon, amorphous carbon, polymeric carbon, coke, meso-porous carbon, carbon fiber, graphite fiber, carbon nano-fiber, carbon nano-tube, and expanded graphite platelets or nano graphene platelets containing multiple graphene planes bonded together);
(b) silicon (Si), germanium (Ge), tin (Sn), lead (Pb), antimony (Sb), bismuth (Bi), zinc (Zn), aluminum (Al), titanium (Ti), and cadmium (Cd);
(c) alloys or intermetallic compounds of Si, Ge, Sn, Pb, Sb, Bi, Zn, Al, Ti, or Cd with other elements, wherein said alloys or compounds are stoichiometric or non-stoichiometric;
(d) oxides, carbides, nitrides, sulfides, phosphides, selenides, and tellurides of Si, Ge, Sn, Pb, Sb, Bi, Zn, Al, Ti, Ni, Co, Mn, Fe, or Cd, and their mixtures, composites, or lithium-containing composites, including Co₃O₄, Mn₃O₄, and their mixtures or composites;
(e) salts and hydroxides of Sn;
(f) lithium titanate, lithium manganate, lithium aluminate, lithium-containing titanium oxide, lithium transition metal oxide; or
(g) a combination thereof.

The multi-component hybrid electrode may be used as a cathode, wherein the intercalation material is a cathode active material capable of storing lithium in interior or bulk of the material. The intercalation material can be any element or compound that is used in a conventional lithium ion battery, lithium metal battery, and lithium-sulfur battery.

Preferably, the intercalation material in a hybrid cathode may be selected from the group consisting of lithium cobalt oxide, cobalt oxide, lithium nickel oxide, nickel oxide, lithium manganese oxide, vanadium oxide V₂O₅, V₃O₈, lithium transition metal oxide, lithiated oxide of transition metal mixture, non-lithiated oxide of a transition metal, non-lithiated oxide of transition metal mixture, lithium iron phosphate, lithium vanadium phosphate, lithium manganese phosphate, a non-lithiated transition metal phosphate, a chalcogen compound, sulfur, sulfur-containing molecule, sulfur-containing compound, sulfur-carbon polymer, sulfur dioxide, thionyl chloride (SOCl₂), oxychloride, manganese dioxide, carbon monofluoride ((CF)ₙ), iron disulfide, copper oxide, lithium copper oxyphosphate (Cu₄O(PO₄)₂), silver vanadium oxide, MoS₂, TiS₂, NbSe₃, and combinations thereof. The intercalation material in such a hybrid cathode can be in a form of nano-scaled particle, wire, rod, tube, ribbon, sheet, film, or coating having a dimension less than 100 nm, preferably less than 20 nm, and most preferably less than 10 nm.

The intercalation-free electrode material may be a cathode active material that forms a porous structure having a specific surface area no less than 100 m²/g, and may be selected from: (a) a porous disordered carbon material selected from activated soft carbon, activated hard carbon, activated polymeric carbon or carbonized resin, activated meso-phase carbon, activated coke, activated carbonized pitch, activated carbon black, activated carbon, or activated partially graphitized carbon; (b) a graphene material selected from a single-layer graphene, multi-layer graphene, graphene oxide, graphene fluoride, hydrogenated graphene, nitrogenated graphene, boron-doped graphene, nitrogen-doped graphene, functionalized graphene, or reduced graphene oxide; (c) a meso-porous exfoliated graphite; (d) a meso-porous carbon; (e) a carbon nanotube (CNT) selected from a single-walled carbon nanotube or multi-walled carbon nanotube, oxidized CNT, fluorinated CNT, hydrogenated CNT, nitrogenated CNT, boron-doped CNT, nitrogen-doped CNT, or doped CNT; (f) a carbon nano-fiber, metal nano-wire, metal oxide nano-wire or fiber, or conductive polymer nano-fiber, or (g) a combination thereof.

The present invention also provides a super-hybrid energy storage device comprising a multi-component hybrid electrode as discussed above. In other words, the super-hybrid device has an electrode (an anode or cathode) that can perform two mechanisms of lithium storage: lithium storage in the interior of an intercalation active material and lithium storage on the surface of an intercalation-free active material. The counter-electrode (a cathode or anode) can be a regular electrode (performing one function only, either intercalation or intercalation-free, but not both) or a hybrid electrode (performing both functions).

In one preferred embodiment, this super-hybrid device contains such a hybrid electrode as an anode, a cathode formed of a porous cathode active material having a specific surface area no less than 100 m²/g in direct contact with electrolyte, a separator disposed between the anode and the cathode, electrolyte in ionic contact with the two electrodes, and at least a lithium source disposed at the anode or cathode prior to the first discharge or charge operation of the device. The super-hybrid device operates on an exchange of lithium ions between a surface and/or interior of an anode active material and a surface of the cathode active material. The cathode active material in this case is itself essentially an intercalation-free active material and can be any cathode active material commonly used in s surface-mediated cell, such as (a) a porous disordered carbon material; (b) a graphene material; (c) a meso-porous exfoliated graphite; (d) a meso-porous carbon; (e) a carbon nanotube (CNT); or (f) a carbon nano-fiber, metal nano-wire, metal oxide nano-wire or fiber, or conductive polymer nano-fiber.

Another embodiment is a super-hybrid energy storage device comprising an anode, a hybrid electrode as a cathode, a separator disposed between the anode and the cathode, electrolyte in ionic contact with the anode and the cathode, and at least a lithium source disposed at the anode or cathode prior to the first discharge or charge of the device. The device operates on an exchange of lithium ions between a surface and/or interior of a cathode active material and a surface of the anode (surface of an anode current collector or anode active material) or interior of an anode active material, if present.

Yet another embodiment is a super-hybrid energy storage device comprising an anode having a current collector and an anode active material, a hybrid electrode as a cathode, a separator disposed between the anode and the cathode, electrolyte in ionic contact with the anode and cathode, and at least a lithium source disposed at the anode or cathode prior to the first discharge or charge of the device. The device operates on the exchange of lithium ions between a surface and/or interior of a cathode active material and a surface of the anode current collector or a surface or interior of the anode active material.

Still another embodiment is a super-hybrid energy storage device comprising a hybrid electrode as an anode, another hybrid electrode as a cathode, a separator disposed between the anode and the cathode, electrolyte in ionic contact with the anode and the cathode, and at least a lithium source disposed at the anode or cathode prior to a first discharge or charge of the device. Both the anode and the cathode can perform two functions (surface storage and bulk storage of lithium). Hence, the device operates on the exchange of lithium ions between a surface and/or interior of a cathode active material and a surface and/or interior of an anode active material.

A particularly desired super-hybrid energy storage device contains two cells internally connected in parallel (having at least one cell being a super-hybrid cell). The device contains: (A) a first anode being formed of a first anode current collector having a surface area to capture or store lithium thereon; (B) a first hybrid cathode comprising a first cathode current collector, a first intercalation-free cathode active material coated on at least a surface of the first cathode current collector, and a first interaction cathode active material coated on a surface of a second cathode current collector, wherein the first and second cathode current collectors are internally connected in parallel; (C) a first porous separator disposed between the first hybrid cathode and the first anode; (D) a lithium-containing electrolyte in physical contact with the first hybrid cathode and first anode; and (E) at least a lithium source implemented at or near at least one of the anodes or cathodes prior to the first charge or first discharge cycle of the energy storage device. Here, the first intercalation-free cathode active material has a specific surface area of no less than 100 m²/g being in direct physical contact with the electrolyte to receive lithium ions therefrom, or to provide lithium ions thereto. Preferably, this super-hybrid energy storage device further comprises a second anode being formed of a second anode current collector having a surface area to capture or store lithium thereon. Preferably, the first anode contains an anode active material having a specific surface area greater than 100 m²/g. In general, the first anode current collector and the second anode current collector are connected to an anode terminal, and the first cathode current collector and the second cathode current collector are connected to a cathode terminal.

The device can be composed of at least two cells with one cell being a super-hybrid cell (having at least a hybrid electrode as an anode or a cathode) and the other cell either a regular intercalation-dominated cell (both the anode and the cathode operating essentially on lithium intercalation and de-intercalation) or a regular intercalation-free cell (surface-mediated cell). It is also desirable to have both two cells being super-hybrid cells (each cell having at least a hybrid electrode).

It is desirable to have at least one of the anode current collectors or cathode current collectors being a porous, electrically conductive material selected from metal foam, metal web or screen, perforated metal sheet, metal fiber mat, metal nanowire mat, porous conductive polymer film, conductive polymer nano-fiber mat or paper, conductive polymer foam, carbon foam, carbon aerogel, carbon xerox gel, graphene foam, graphene oxide foam, reduced graphene oxide foam, carbon fiber paper, graphene paper, graphene oxide paper, reduced graphene oxide paper, carbon nano-fiber paper, carbon nano-tube paper, or a combination thereof.

In a super-hybrid device, at least one of the cells contains therein a lithium source prior to a first charge or a first discharge cycle of the energy storage device. The lithium source may be preferably in a form of solid lithium foil, lithium chip, lithium powder, or surface-stabilized lithium particles. The lithium source may be a layer of lithium thin film pre-loaded on surfaces of an electrode active material or a current collector. In one preferred embodiment, the entire device has just one lithium source. Preferably, the lithium source is a lithium thin film or coating pre-plated on the surface of an anode current collector or anode active material, or simply a sheet of lithium foil implemented near or on a surface of an anode current collector or anode active material.

The surfaces of a hybrid electrode material in a super-hybrid cell or an intercalation-free material in a SMC are capable of capturing lithium ions directly from a liquid electrolyte phase and storing lithium atoms on the surfaces in a reversible and stable manner. The electrolyte preferably comprises liquid electrolyte (e.g. organic liquid or ionic liquid) or gel electrolyte in which lithium ions have a high diffusion coefficient. Solid electrolyte is normally not desirable, but some thin layer of solid electrolyte may be used if it exhibits a relatively high diffusion rate.

### BRIEF DESCRIPTION OF THE DRAWINGS

FIG. 1 (A) a prior art electric double-layer (EDL) supercapacitor in the charged state; (B) the same EDL supercapacitor in the discharged state; (C) a prior art lithium-ion battery (LIB) cell in the charged state; (D) the same LIB in the discharged state; (E) a prior art lithium-ion capacitor (LIC) cell in the charged state, using graphite particles as the anode active material and activated carbon (AC) as the cathode active material; (F) the same LIC in the discharged state; (G) another prior art LIC using lithium titanate as the anode active material and AC as the cathode active material.

FIG. 2 (A) The structure of a SMC when it is made (prior to the first discharge or charge cycle), containing a nano-structured material at the anode, a lithium source (e.g. lithium foil or surface-stabilized lithium powder), a porous separator, liquid electrolyte, a porous nano-structured material at the cathode having a high specific surface area; (B) The structure of this SMC after its first discharge operation (lithium is ionized with the lithium ions diffusing through liquid electrolyte to reach the surfaces of nano-structured cathode and get rapidly captured by these surfaces); (C) The structure of this battery device after being re-charged (lithium ions are released from the cathode surfaces, diffusing through liquid electrolyte to reach the surfaces of the nano-structured anode and get rapidly plated onto these surfaces). The large surface areas can serve as a supporting substrate onto which massive amounts of lithium ions can electro-deposit concurrently.

FIG. 3 (A) A prior art anode containing an anode current collector and a layer of intercalation anode active material (e.g. graphite or carbon particles) coated on a surface of this current collector; (B) A prior art cathode containing a cathode current collector and a layer of intercalation cathode active material (e.g. lithium iron phosphate or lithium manganese oxide particles) coated on a surface of this current collector; (C) A prior art electrode containing a layer of intercalation-free electrode material (e.g. isolated graphene sheets re-constituted into meso-porous particles) commonly used in a SMC cathode; (D) A hybrid electrode containing a layer of intercalation-free active material and a layer of graphite intercalation compound bonded to a surface of an anode current collector according to a preferred embodiment of the present invention; (E) A hybrid electrode containing a layer of intercalation-free active material and a layer of intercalation active material respectively bonded to two opposing surfaces of an anode current collector according to another preferred embodiment of the present invention; and (F) A hybrid electrode containing a mixture layer of an intercalation-free active material and an intercalation active material bonded to a surface of an electrode current collector according to yet another preferred embodiment of the present invention.

FIG. 4 Two preferred embodiments of the present invention: (A) a super-hybrid cell containing a hybrid electrode (current collector 40+intercalation compound 42+intercalation-free active material 44 combined) as an anode, a lithium source (e.g. Li particles 46), a porous separator 48, an intercalation-free active material 50 coated on a surface of a cathode current collector 52, and electrolyte in contact with both the anode and cathode; (B) a super-hybrid cell containing an intercalation-free anode (=an anode current collector 60+an intercalation-free anode active material 64), a lithium source (e.g. Li particles 66), a porous separator 68, a hybrid electrode (=an intercalation-free cathode active material 70 and an intercalation cathode active material 74 coated on two opposing surfaces of a porous cathode current collector 72, and electrolyte in contact with both the anode and cathode.

FIG. 5 Schematic of a super-hybrid cell: (A) After the cell is made, but prior to the first discharge; (B) after first discharge; and (C) after a re-charge.

FIG. 6 Potential lithium storage mechanisms of an intercalation-free electrode material: (A) Schematic of a weak or negligible lithium storage mechanism (the functional group attached to an edge or surface of an aromatic ring or small graphene sheet can readily react with a lithium ion to form a redox pair); (B) Possible formation of electric double layers as a minor or negligible mechanism of charge storage in a SMC; (C) A major lithium storage mechanism (lithium captured at a benzene ring center of a graphene plane), which is fast, reversible, and stable; (D) Another lithium storage mechanism (lithium atoms trapped in a graphene surface defect).

FIG. 7 Ragone plots of an activated soft carbon cathode-based SMC, a super-hybrid cell (containing a graphene/LiCoO₂ hybrid cathode), a corresponding LIB, and a corresponding EDL supercapacitor.

FIG. 8 Ragone plots of an NGP/activated soft carbon SMC, a lithium metal rechargeable cell (Li/LiV₃O₈), and a super-hybrid cell (NGP anode and NGP layer/V₃O₈ layer hybrid cathode).

FIG. 9 (A) Ragone plot of a super-hybrid cell (graphite/graphene hybrid anode, intercalation-free meso-porous carbon cathode), a lithium-ion capacitor cell (graphite anode and meso-porous carbon cathode), a SMC (meso-porous carbon anode and cathode, plus Li foil), and a symmetric supercapacitor (meso-porous carbon anode and cathode); (B) Self-discharge curves of the SMC and the super-hybrid cell.

FIG. 10 Ragone plots of a Li—S cell (Li metal anode and graphene-wrapped S particle cathode) and a super-hybrid cell (cathode=intercalation-free graphene layer+current collector+graphene-wrapped S particle layer).

### DESCRIPTION OF THE PREFERRED EMBODIMENTS

The present invention provides a multi-component hybrid electrode for use in an electrochemical super-hybrid energy storage device. The hybrid electrode itself is a hybrid of two electrode materials and, hence, an energy storage cell containing a hybrid electrode is herein referred to as a super-hybrid cell.

The electrode in a conventional lithium-ion battery is normally a single-functional electrode performing either an intercalation-based lithium storage mechanism (storing lithium in the interior of an electrode active material) or an intercalation-free mechanism (storing lithium on the surface of an electrode active material), but not both.

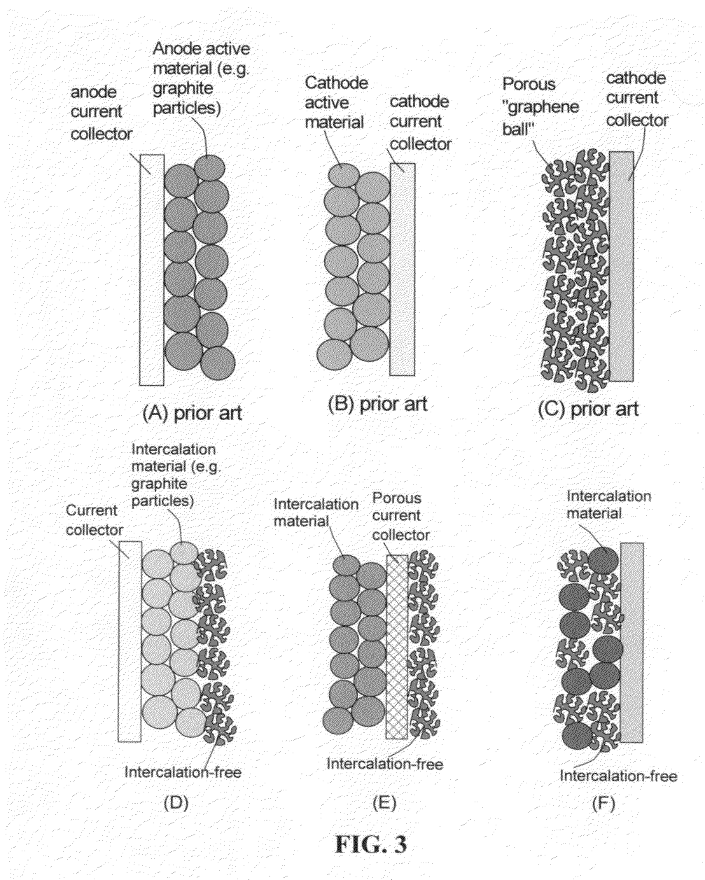

Schematically shown in FIG. 3 are several prior art single-functional electrode and several hybrid electrodes of the present invention. For instance, FIG. 3(A) shows a prior art anode containing an anode current collector and a layer of intercalation anode active material (e.g. graphite or carbon particles) coated on a surface of this current collector. A LIB featuring such an anode requires lithium to undergo intercalation into the interior (e.g. interstitial spaces between two graphene planes) of a graphite particle during re-charge, and de-intercalation of lithium from the interior of the graphite particle when the LIB is discharged. Both the intercalation and de-intercalation procedures involve very slow solid-state diffusion, resulting in a low power density and long re-charge time.

FIG. 3(B) schematically shows a prior art cathode containing a cathode current collector and a layer of intercalation cathode active material (e.g. lithium iron phosphate or lithium manganese oxide particles) coated on a surface of this current collector. Again, this conventional cathode requires the slow solid-state diffusion to accomplish the lithium intercalation and de-intercalation. FIG. 3(C) shows a prior art electrode containing a layer of intercalation-free electrode material (e.g. isolated graphene sheets re-constituted into meso-porous particles) commonly used in a SMC cathode recently invented by our research group. These graphene sheets have surfaces directly exposed to liquid electrolyte and are capable of reversibly capturing and storing lithium on surfaces (not through intercalation).

A preferred embodiment of the present invention, as schematically shown in FIG. 3(D), is a hybrid electrode containing a layer of intercalation-free active material and a layer of graphite intercalation compound bonded to a surface of an anode current collector. Such a hybrid electrode can perform dual functions, storing lithium on surfaces of an intercalation-free material, such as various different types of graphene, and storing lithium in the interior of graphite particles through intercalation. Any graphene-rich carbon material that can be made into a porous electrode having a specific surface area greater than 100 m²/g (preferably greater than 500 m²/g, more preferably greater than 1,000 m²/g, and most preferably greater than 1,500 m²/g) can be used as an intercalation-free electrode active material.

Useful graphene-rich carbon materials include: (a) a porous disordered carbon material selected from activated soft carbon, activated hard carbon, activated polymeric carbon or carbonized resin, activated meso-phase carbon, activated coke, activated carbonized pitch, activated carbon black, activated carbon, or activated partially graphitized carbon; (b) a graphene material selected from a single-layer graphene, multi-layer graphene, graphene oxide, graphene fluoride, hydrogenated graphene, nitrogenated graphene, boron-doped graphene, nitrogen-doped graphene, functionalized graphene, or reduced graphene oxide; (c) a meso-porous exfoliated graphite; (d) a meso-porous carbon; (e) a carbon nanotube (CNT) selected from a single-walled carbon nanotube or multi-walled carbon nanotube, oxidized CNT, fluorinated CNT, hydrogenated CNT, nitrogenated CNT, boron-doped CNT, nitrogen-doped CNT, or doped CNT; and (f) a carbon nano-fiber. These nano-structured carbon materials contain some graphene sheets, small or large, as a constituent ingredient. For instance, a single-wall CNT is essentially a layer of graphene rolled up into a tubular shape. The disordered carbon must be chemically or physically activated, or exfoliated to produce meso-scaled pores (>2 nm) and/or expanding the inter-graphene spacing to >2 nm, allowing liquid electrolyte to access graphene surfaces.

According to another preferred embodiment of the present invention, a hybrid electrode can contain a layer of intercalation-free active material and a layer of intercalation active material respectively bonded to two opposing surfaces of an electrode current collector, as illustrated in FIG. 3(E). The current collector is preferably porous to enable easy passage of lithium ions. Shown in FIG. 3(F) is a hybrid electrode containing a mixture layer of an intercalation-free active material and an intercalation active material bonded to a surface of an electrode current collector according to yet another preferred embodiment of the present invention. The two active materials are mixed and then coated to one or two surfaces of a current collector.

The porous current collector can be an electrically conductive material that forms a porous structure (preferably meso-porous having a pore size in the range of 2 nm and 50 nm). This conductive material may be selected from metal foam, metal web or screen, perforated metal sheet (having pores penetrating from a front surface to a back surface), metal fiber mat, metal nanowire mat, porous conductive polymer film, conductive polymer nano-fiber mat or paper, conductive polymer foam, carbon foam, carbon aerogel, carbon xerox gel, graphene foam, graphene oxide foam, reduced graphene oxide foam, carbon fiber paper, graphene paper, graphene oxide paper, reduced graphene oxide paper, carbon nano-fiber paper, carbon nano-tube paper, or a combination thereof. These materials can be readily made into an electrode that is porous (preferably having a specific surface area greater than 50 m²/g, more preferably >100 m²/g, further preferably >500 m²/g, even more preferably >1,000 m²/g, and most preferably >1,500 m²/g), allowing liquid electrolyte and the lithium ions contained therein to migrate through.

In an alternative configuration, a hybrid electrode can be composed of two or more current collectors internally connected in parallel, wherein at least one current collector having an intercalation active material coated thereon and at least one current collector having an intercalation-free active material coated thereon.

For use in a cathode, the intercalation electrode active material of a hybrid electrode may be selected from a broad range of cathode active materials that are capable of storing lithium in interior or bulk of the material. The intercalation material can be any element or compound used in a conventional lithium ion battery, lithium metal battery, and lithium-sulfur battery.

Preferably, the intercalation material in a hybrid cathode (a hybrid electrode used as a cathode) may be selected from the group consisting of lithium cobalt oxide, cobalt oxide, lithium nickel oxide, nickel oxide, lithium manganese oxide, vanadium oxide V₂O₅, V₃O₈, lithium transition metal oxide, lithiated oxide of transition metal mixture, non-lithiated oxide of a transition metal, non-lithiated oxide of transition metal mixture, lithium iron phosphate, lithium vanadium phosphate, lithium manganese phosphate, a non-lithiated transition metal phosphate, a chalcogen compound, sulfur, sulfur-containing molecule, sulfur-containing compound, sulfur-carbon polymer, sulfur dioxide, thionyl chloride (SOCl₂), oxychloride, manganese dioxide, carbon monofluoride ((CF)ₙ), iron disulfide, copper oxide, lithium copper oxyphosphate (Cu₄O(PO₄)₂), silver vanadium oxide, MoS₂, TiS₂, NbSe₃, and combinations thereof. The intercalation material in such a hybrid cathode can be in a form of nano-scaled particle, wire, rod, tube, ribbon, sheet, film, or coating having a dimension less than 100 nm, preferably less than 20 nm, and most preferably less than 10 nm.

For use in an anode, the intercalation active material of a hybrid electrode may be selected from the following: (A) a graphite or carbonaceous intercalation compound having a specific surface area less than 100 m²/g (preferably less than 50 m²/g, further preferably less than 10 m²/g) when formed into an anode (e.g. the intercalation compound may be selected from natural graphite, synthetic graphite, meso-phase carbon, soft carbon, hard carbon, amorphous carbon, polymeric carbon, coke, meso-porous carbon, carbon fiber, graphite fiber, carbon nano-fiber, carbon nano-tube, and expanded graphite platelets or nano graphene platelets containing multiple graphene planes bonded together); (B) silicon (Si), germanium (Ge), tin (Sn), lead (Pb), antimony (Sb), bismuth (Bi), zinc (Zn), aluminum (Al), titanium (Ti), and cadmium (Cd); (C) alloys or intermetallic compounds of Si, Ge, Sn, Pb, Sb, Bi, Zn, Al, Ti, or Cd with other elements, wherein said alloys or compounds are stoichiometric or non-stoichiometric; (D) oxides, carbides, nitrides, sulfides, phosphides, selenides, and tellurides of Si, Ge, Sn, Pb, Sb, Bi, Zn, Al, Ti, Ni, Co, Mn, Fe, or Cd, and their mixtures, composites, or lithium-containing composites, including Co₃O₄, Mn₃O₄, and their mixtures or composites; (E) salts and hydroxides of Sn; (F) lithium titanate, lithium manganate, lithium aluminate, lithium-containing titanium oxide, lithium transition metal oxide; or (G) a combination thereof.

The present invention also provides a super-hybrid cell containing at least a hybrid electrode as an anode or a cathode. As schematically illustrated in FIG. 4(A), a preferred embodiments of the present invention is a super-hybrid cell containing a hybrid electrode (current collector 40+intercalation compound 42+intercalation-free active material 44 combined together) as an anode, a lithium source (e.g. Li particles 46), a porous separator 48, an intercalation-free active material 50 coated on a surface of a cathode current collector 52, and electrolyte in contact with both the anode and cathode.

FIG. 4(B) illustrates another super-hybrid cell containing an intercalation-free anode (=an anode current collector 60+an intercalation-free anode active material 64), a lithium source (e.g. Li particles 66), a porous separator 68, a hybrid electrode (=an intercalation-free cathode active material 70 and an intercalation cathode active material 74 coated on two opposing surfaces of a porous cathode current collector 72, and electrolyte in contact with both the anode and cathode.

In a preferred embodiment, a super-hybrid cell can contain a hybrid anode and a hybrid cathode. Further alternatively, a super-hybrid device may contain a hybrid electrode that is formed of two current collectors internally connected in parallel with one current collector supporting at least a layer of intercalation active material and the other current collector supporting at least a layer of intercalation-free active material

The lithium source in a super-hybrid cell preferably comprises a lithium chip, lithium foil, lithium powder, surface stabilized lithium particles, lithium film coated on a surface of an anode or cathode current collector, lithium film coated on a surface of an anode or cathode active material, or a combination thereof. Coating of lithium on the surfaces of a current collector or an electrode can be accomplished via electrochemical deposition (plating), sputtering, vapor deposition, etc. Preferably, at least one of the anode current collectors or at least one of the cathode active materials is pre-loaded (pre-lithiated, pre-coated, or pre-plated) with lithium before or when the stack is made.

The electrolyte is preferably liquid electrolyte or gel electrolyte containing a first amount of lithium ions dissolved therein. The operation of an SMC cell or a super-hybrid cell involves an exchange of a second amount of lithium ions between the cathodes and the anodes, and this second amount of lithium is greater than the first amount.

Although there is no limitation on the electrode thickness, the active material layer coated on a current collector in a presently invented hybrid electrode preferably has a thickness greater than 5 μm, more preferably greater than 50 μm, and most preferably greater than 100 μm.

Another preferred embodiment of the present invention is a stack of electrochemical cells that are internally connected in series or in parallel, containing at least one hybrid electrode.

The invention further provides a super-hybrid energy storage device, which is internally connected to an electrochemical energy storage device in series or in parallel, wherein the electrochemical energy storage device is selected from a supercapacitor, a lithium-ion capacitor, a lithium-ion battery, a lithium metal secondary battery, a lithium-sulfur cell, a surface-mediated cell (f-SMC or p-SMC), or another super-hybrid cell containing a hybrid electrode.

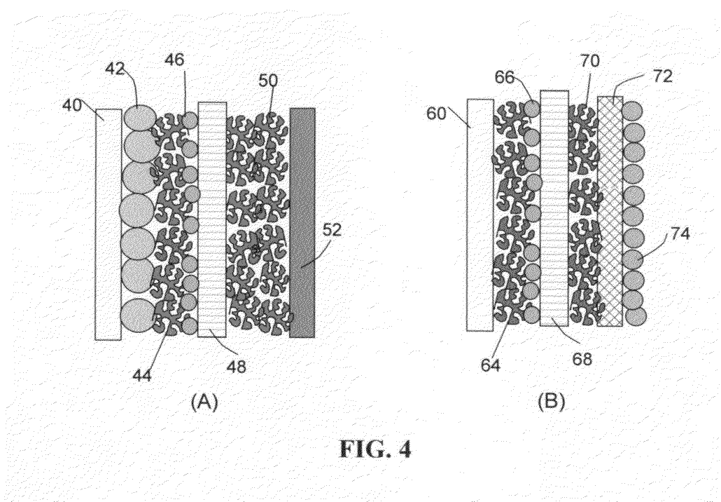

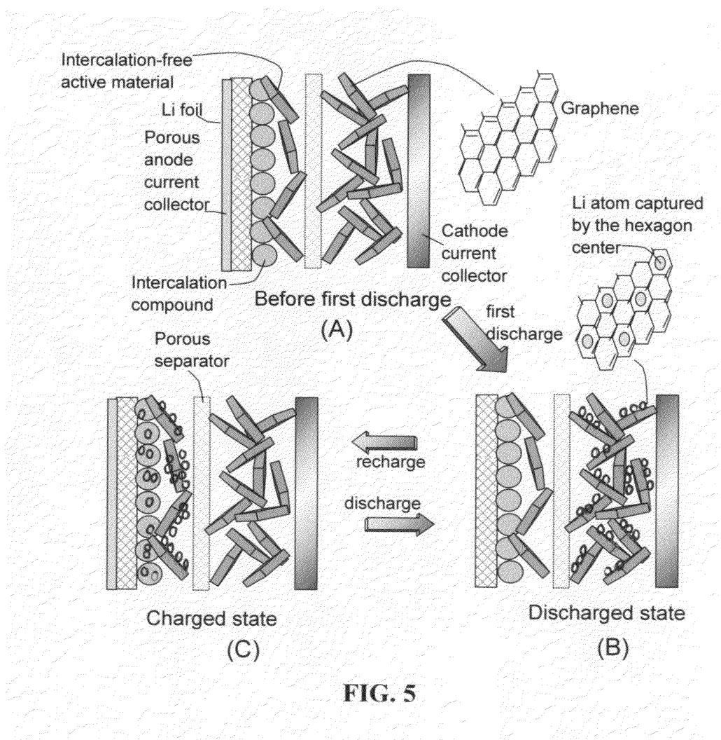

The operation of a super-hybrid cell may be illustrated in FIG. 5. FIG. 5(A) schematically shows a super-hybrid cell prior to the first discharge of this cell. The anode is a hybrid anode containing an intercalation compound (e.g. graphite particles) and an intercalation-free anode active material (e.g. graphene sheets) stacked together and bonded to a surface of a porous anode current collector. A lithium source (lithium foil) is disposed on the opposing surface of this current collector.

During the first discharge of this super-hybrid cell, lithium foil is ionized, releasing lithium ions into electrolyte, penetrating through the porous anode current collector and porous anode active material layers, migrating through the porous separator, reaching the cathode side through liquid electrolyte, and get captured by the surfaces of an intercalation-free cathode active material (FIG. 5(B)). These lithium ions are stored at the benzene ring centers, trapped at surface defects, or captured by surface/edge-borne functional groups. Very few lithium ions remain in the liquid electrolyte phase.

When this super-hybrid cell is re-charged, massive lithium ions are released immediately from the surfaces of a cathode active material having a high specific surface area. Under the influence of an electric field generated by an outside battery charger, lithium ions are driven to swim in liquid electrolyte through the porous separator and reach the anode side. With a hybrid anode, some of the lithium ions can get captured by surfaces of the intercalation-free active materials (e.g. graphene or meso-porous carbon) in a short period of time. The remaining lithium ions will take time to intercalate into the interior of graphite particles.

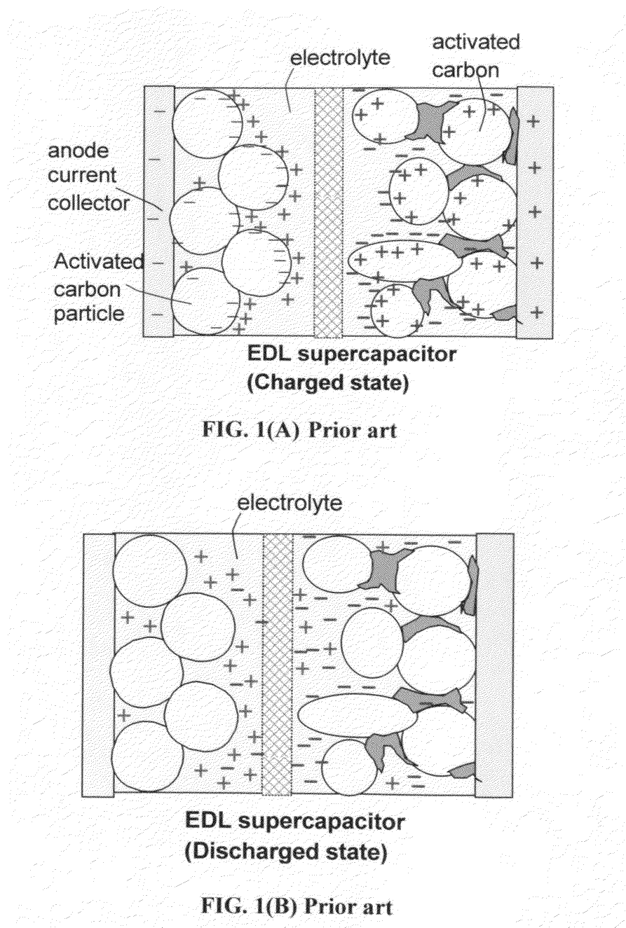

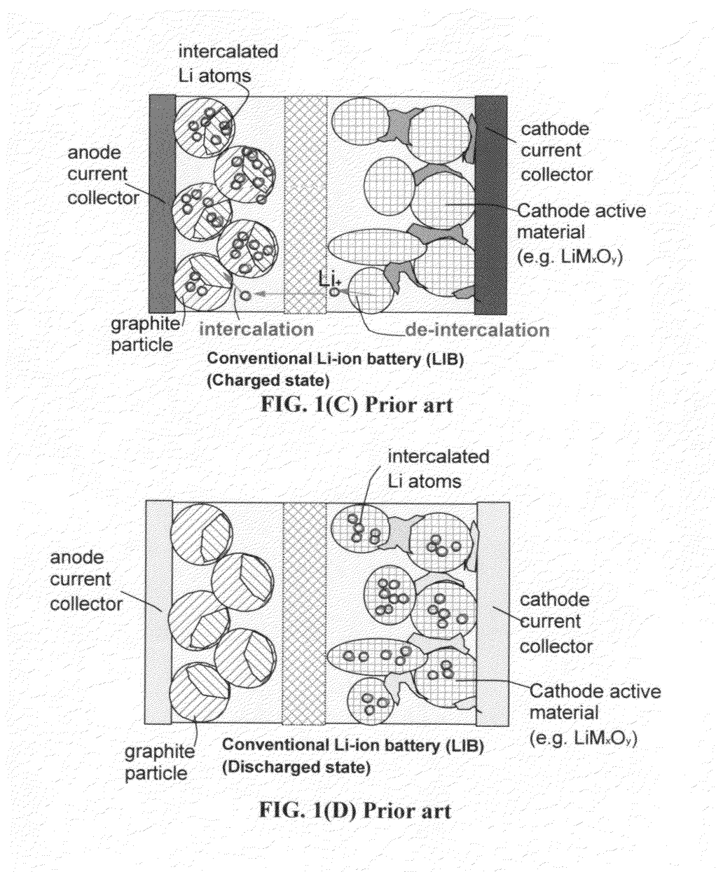

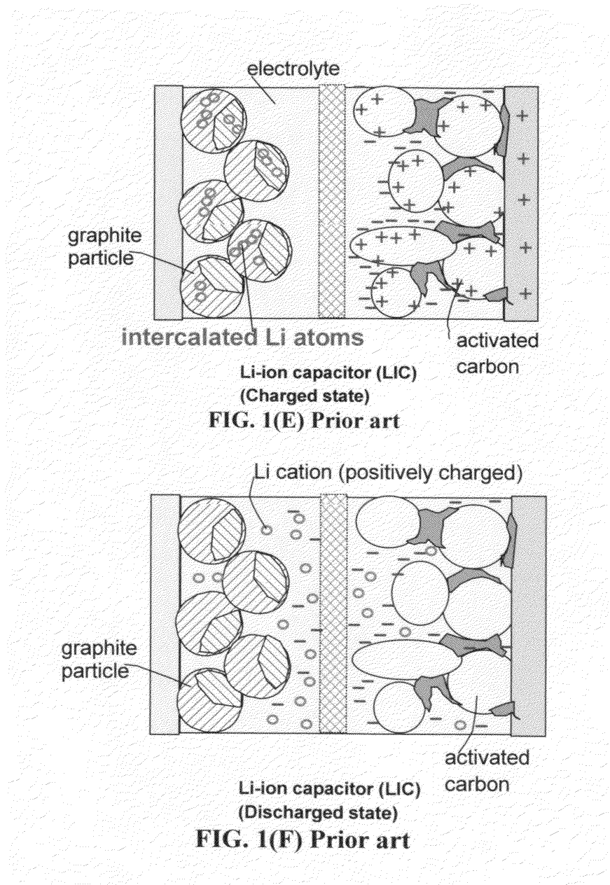

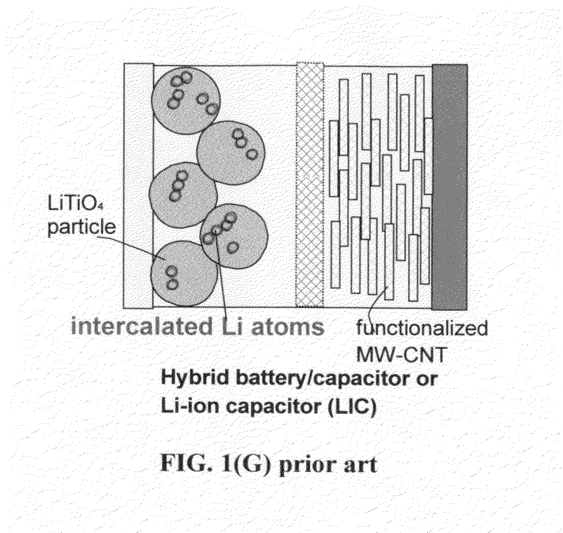

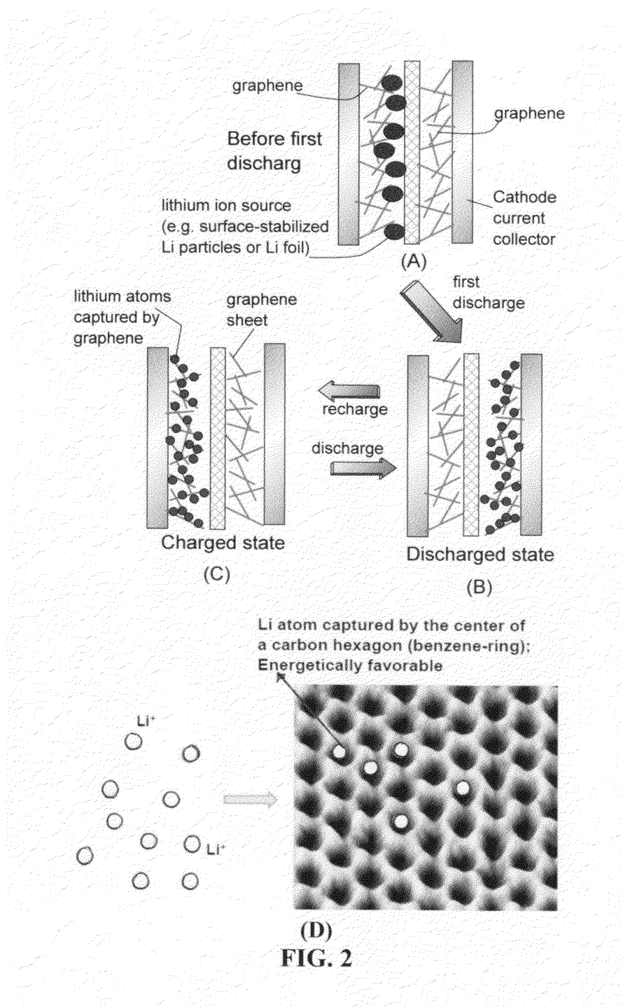

This new super-hybrid cell has an intercalation-free electrode, similar to what is used in a surface-mediated cell (SMC). However, this super-hybrid cell has several unique and novel properties that are not found with the SMC or any other electrochemical energy storage device, as demonstrated in the Examples. In addition, the super-hybrid cell is also patently distinct from the conventional supercapacitor in the following aspects:
(1) The conventional supercapacitors do not have a lithium ion source implemented at the anode when the cell is made.
(2) The electrolytes used in these prior art supercapacitors are mostly lithium-free or non-lithium-based. Even when a lithium salt is used in a supercapacitor electrolyte, the solubility of lithium salt in a solvent essentially sets an upper limit on the amount of lithium ions that can participate in the formation of electric double layers of charges inside the electrolyte phase (near but not on an electrode material surface, as illustrated in FIG. 1(A)). As a consequence, the specific capacitance and energy density of the resulting supercapacitor are relatively low (e.g. typically <6 Wh/kg based on the total cell weight), as opposed to, for instance, 200 Wh/kg (based on the total cell weight) of super-hybrid or surface-mediated cells.
(3) The prior art supercapacitors are based on either the electric double layer (EDL) mechanism or the pseudo-capacitance mechanism to store their charges. In both mechanisms, no lithium ions are exchanged between the two electrodes (even when a lithium salt is used in electrolyte). In the EDL mechanism, for instance, the cations and anions in the electrolyte form electric double layers of charges near the surfaces of an anode and a cathode active material (but not on the surface) when the supercapacitor is in the charged state. The cations are not captured or stored in the bulk or on the surfaces of the electrode active material. In contrast, using graphene as an example of an intercalation-free electrode active material in a super-hybrid cell of the present invention, lithium atoms can be captured or trapped at the defect sites and benzene ring centers of a graphene plane. The functional groups, if present on graphene surfaces/edges, may also be used to capture lithium. Lithium may also intercalate into the interior of an intercalation compound in a super-hybrid cell.
(4) In the EDLs, the cations and anions are attracted to the anode and the cathode, respectively, when the supercapacitor is charged. When the supercapacitor is discharged, the charges on activated carbon particle surfaces are used or disappear and, consequently, the negatively charged species and the positively charged species of the salt become randomized and re-dispersed in the electrolyte phase (not on the activated carbon particle surfaces). In contrast, when the super-hybrid cell is in a charged state, the majority of lithium ions are attracted to attach or electro-plate on the anode (or intercalate into an anode intercalation compound, such as graphite), and the cathode side is essentially free of any moveable lithium. After discharge, essentially all the lithium atoms are captured by the cathode active material surfaces or bulk with no or little lithium staying inside the electrolyte.
(5) The symmetric or EDL supercapacitors using a lithium salt-based organic electrolyte operate only in the range of 0-2.7 volts. They cannot operate above 3 volts; there is no additional charge storing capability beyond 3 volts and actually the organic electrolyte typically begins to break down at 2.7 volts. In contrast, the surface-mediated cells of the present invention operate typically in the range of 1.0-4.5 volts.
(6) This point is further supported by the fact that the prior art EDL supercapacitor typically has an open-circuit voltage of approximately 0 volts. In contrast, the super-hybrid cell typically has an open-circuit voltage of >0.6 volts, more commonly >0.8 volts, and most commonly >1.0 volts (some >1.2 volts or even >1.5 volts, depending on the type and amount of the anode active material relative to the cathode, and the amount of the lithium source).

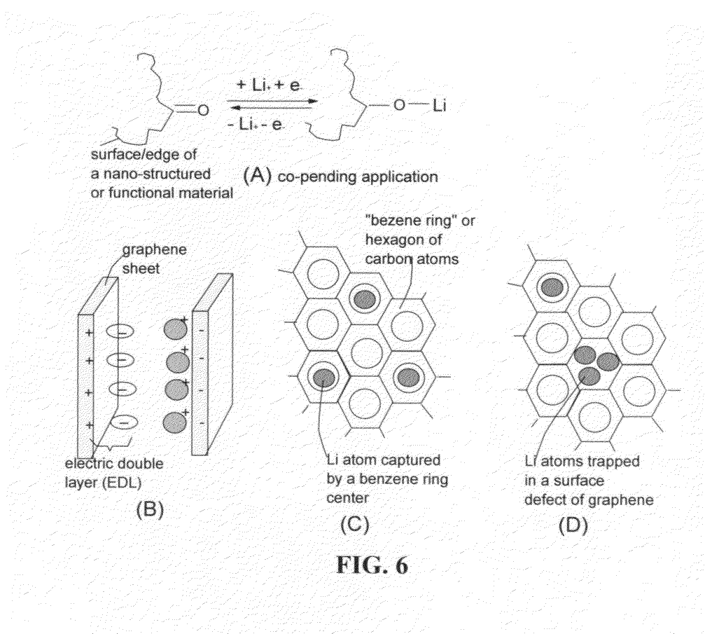

Our earlier studies [Ref. 1-6 cited earlier] have established that the specific capacity of an intercalation-free electrode in a SMC is governed by the number of active sites on graphene surfaces of a nano-structured carbon material that are capable of capturing lithium ions thereon, as illustrated in FIG. 6. The nano-structured carbon material may be selected from activated carbon (AC), activated carbon black (CB), activated hard carbon, activated soft carbon, meso-porous exfoliated graphite (EG), and isolated graphene sheets (nano graphene platelet or NGP) from natural graphite or artificial graphite. These carbon materials have a common building block—graphene or graphene-like aromatic ring structure. We also proposed that there are four possible lithium storage mechanisms associated with an intercalation-free electrode active material:
Mechanism 1: The geometric center of a benzene ring in a graphene plane is an active site for a lithium atom to adsorb onto;
Mechanism 2: The defect site on a graphene sheet is capable of trapping a lithium ion;
Mechanism 3: The cations (Li⁺) and anions (from a Li salt) in the liquid electrolyte are capable of forming electric double layers of charges near the electrode material surfaces;
Mechanism 4: A functional group (if any) on a graphene surface/edge can form a redox pair with a lithium ion.

Single-layer graphene or the graphene plane (a layer of carbon atoms forming a hexagonal or honeycomb-like structure) is a common building block of a wide array of graphitic materials, including natural graphite, artificial graphite, soft carbon, hard carbon, coke, activated carbon, carbon black, etc. In these graphitic materials, typically multiple graphene sheets are stacked along the graphene thickness direction to form an ordered domain or crystallite of graphene planes. Multiple crystallites of domains are then connected with disordered or amorphous carbon species. In the instant application, we are able to extract or isolate these crystallites or domains to obtain multiple-layer graphene platelets out of the disordered carbon species. In some cases, we exfoliate and separate these multiple-graphene platelets into isolated single-layer graphene sheets. In other cases (e.g. in activated carbon, hard carbon, and soft carbon), we chemically removed some of the disordered carbon species to open up gates, allowing liquid electrolyte to enter into the interior (exposing graphene surfaces to electrolyte).

In the present application, nano graphene platelets (NGPs) or “graphene materials” collectively refer to single-layer and multi-layer versions of graphene, graphene oxide, graphene fluoride, hydrogenated graphene, nitrogenated graphene, doped graphene, boron-doped graphene, nitrogen-doped graphene, etc.

The disordered carbon material may be selected from a broad array of carbonaceous materials, such as a soft carbon, hard carbon, polymeric carbon (or carbonized resin), meso-phase carbon, coke, carbonized pitch, carbon black, activated carbon, or partially graphitized carbon. A disordered carbon material is typically formed of two phases wherein a first phase is small graphite crystal(s) or small stack(s) of graphite planes (with typically up to 10 graphite planes or aromatic ring structures overlapped together to form a small ordered domain) and a second phase is non-crystalline carbon, and wherein the first phase is dispersed in the second phase or bonded by the second phase. The second phase is made up of mostly smaller molecules, smaller aromatic rings, defects, and amorphous carbon. Typically, the disordered carbon is highly porous (e.g., activated carbon) or present in an ultra-fine powder form (e.g. carbon black) having nano-scaled features (hence, a high specific surface area).

Soft carbon refers to a carbonaceous material composed of small graphite crystals wherein the orientations of these graphite crystals or stacks of graphene sheets are conducive to further merging of neighboring graphene sheets or further growth of these graphite crystals or graphene stacks using a high-temperature heat treatment (graphitization). Hence, soft carbon is said to be graphitizable. Hard carbon refers to a carbonaceous material composed of small graphite crystals wherein these graphite crystals or stacks of graphene sheets are not oriented in a favorable directions (e.g. nearly perpendicular to each other) and, hence, are not conducive to further merging of neighboring graphene sheets or further growth of these graphite crystals or graphene stacks (i.e., not graphitizable).

Carbon black (CB), acetylene black (AB), and activated carbon (AC) are typically composed of domains of aromatic rings or small graphene sheets, wherein aromatic rings or graphene sheets in adjoining domains are somehow connected through some chemical bonds in the disordered phase (matrix). These carbon materials are commonly obtained from thermal decomposition (heat treatment, pyrolyzation, or burning) of hydrocarbon gases or liquids, or natural products (wood, coconut shells, etc). The preparation of polymeric carbons by simple pyrolysis of polymers or petroleum/coal tar pitch materials has been known for approximately three decades. When polymers such as polyacrylonitrile (PAN), rayon, cellulose and phenol formaldehyde were heated above 300° C. in an inert atmosphere they gradually lost most of their non-carbon contents. The resulting structure is generally referred to as a polymeric carbon.

Polymeric carbons can assume an essentially amorphous structure, or have multiple graphite crystals or stacks of graphene planes dispersed in an amorphous carbon matrix. Depending upon the HTT used, various proportions and sizes of graphite crystals and defects are dispersed in an amorphous matrix. Various amounts of two-dimensional condensed aromatic rings or hexagons (precursors to graphene planes) can be found inside the microstructure of a heat treated polymer such as a PAN fiber. An appreciable amount of small-sized graphene sheets are believed to exist in PAN-based polymeric carbons treated at 300-1,000° C. These species condense into wider aromatic ring structures (larger-sized graphene sheets) and thicker plates (more graphene sheets stacked together) with a higher HTT or longer heat treatment time (e.g., >1,500° C.). These graphene platelets or stacks of graphene sheets (basal planes) are dispersed in a non-crystalline carbon matrix. Such a two-phase structure is a characteristic of some disordered carbon material.

Certain grades of petroleum pitch or coal tar pitch may be heat-treated (typically at 250-500° C.) to obtain a liquid crystal-type, optically anisotropic structure commonly referred to as meso-phase. This meso-phase material can be extracted out of the liquid component of the mixture to produce meso-phase particles or spheres, which can be carbonized and optionally graphitized. A commonly used meso-phase carbon material is referred to as meso-carbon micro-beads (MCMBs).

Physical or chemical activation may be conducted on all kinds of disordered carbon (e.g. a soft carbon, hard carbon, polymeric carbon or carbonized resin, meso-phase carbon, coke, carbonized pitch, carbon black, activated carbon, or partially graphitized carbon) to obtain activated disordered carbon. For instance, the activation treatment can be accomplished through oxidizing, CO₂ physical activation, KOH or NaOH chemical activation, or exposure to nitric acid, fluorine, or ammonia plasma (for the purpose of creating electrolyte-accessible pores, not for functionalization).

The following examples serve to illustrate the preferred embodiments of the present invention and should not be construed as limiting the scope of the invention:

### Example 1

### Soft Carbon (One Type of Disordered Carbon) for Hybrid Electrodes

Soft carbon materials were prepared from a liquid crystalline aromatic resin. The resin was ground with a mortar, and calcined at 900° C. for 2 h in a N₂ atmosphere to prepare the graphitizable carbon or soft carbon. The resulting soft carbon was mixed with small tablets of KOH (four-fold weight) in an alumina melting pot. Subsequently, the soft carbon containing KOH was heated at 750° C. for 2 h in N₂. Upon cooling, the alkali-rich residual carbon was washed with hot water until the outlet water reached a pH value of 7. The resulting material is activated soft carbon.

Coin cells were made that contain activated soft carbon as a cathode intercalation-free material and LiCO₂ as an intercalation cathode active material, activated soft carbon as a nano-structured anode, and a thin piece of lithium foil as a lithium source implemented between a current collector and a separator layer. Corresponding SMC cells without LiCO₂ were also prepared and tested for comparison. In all cells, the separator used was one sheet of micro-porous membrane (Celgard 2500). The current collector for each of the two cathodes was a piece of porous carbon-coated aluminum foil.

For the super-hybrid cell, the front surface (facing the separator) of the porous cathode current collector was coated with activated soft carbon layer composed of a composite composed of 85 wt. % activated soft carbon (+5% Super-P and 10% PTFE binder). The back surface was coated with a composite layer composed of 85 wt. % LiCO₂ (+5% Super-P and 10% PTFE binder). The electrolyte solution was 1 M LiPF₆ dissolved in a mixture of ethylene carbonate (EC) and dimethyl carbonate (DMC) with a 3:7 volume ratio. The separator was wetted by a minimum amount of electrolyte to reduce the background current. Cyclic voltammetry and galvanostatic measurements of the lithium cells were conducted using an Arbin 32-channel supercapacitor-battery tester at room temperature (in some cases, at a temperature as low as −40° C. and as high as 60° C.).

As a reference sample, a similar Lithium-ion cell having a natural graphite-based intercalation anode active material and LiCO₂ cathode was made and tested. Additionally, a symmetric supercapacitor with both electrodes being composed of an activated soft carbon material, but containing no additional lithium source than what is available in the liquid electrolyte, was also fabricated and evaluated.

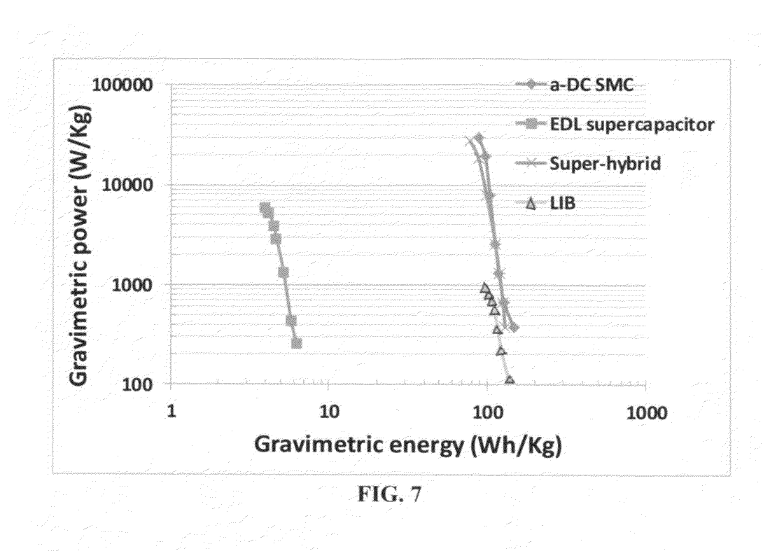

Galvanostatic studies of these four samples have enabled us to obtain significant data as summarized in the Ragone plot of FIG. 7 (all power density and energy density data being based on the total cell weight, not single-electrode weight). These plots allow us to make the following observations: (a) Both the SMC and the super-hybrid cell exhibit significantly higher power densities than those of the corresponding lithium-ion battery. This demonstrates that the presence of an intercalation-free, meso-porous cathode (in addition to a nano-structured anode and a lithium source) enables high rates of lithium ion deposition onto and releasing from the massive surface areas of the cathode during the discharge and re-charge cycles, respectively; (b) Both the SMC and the super-hybrid cell exhibit significantly higher energy densities and power densities than those of the corresponding symmetric supercapacitors. The amounts of lithium ions and their counter-ions (anions) are limited by the solubility of a lithium salt in the solvent. The amounts of lithium that can be captured and stored in the active material surfaces of either electrode are dramatically higher than this solubility limit.

### Example 2

### NGPs from Sulfuric Acid Intercalation and Exfoliation of Natural Graphite, an NGP/NGP SMC, a Lithium Metal Rechargeable Cell (Li/LiV₃O₈), a Super-Hybrid Cell (NGP Anode and NGP Layer/V₃O₈ Layer Hybrid Cathode)

Natural graphite (HuaDong Graphite Co., Qingdao, China) having a median size of about 45 microns and an inter-planar distance of about 0.335 nm was intercalated with an acid solution (sulfuric acid, nitric acid, and potassium permanganate at a ratio of 4:1:0.05) for 72 hours. Upon completion of the reaction, the mixture was poured into deionized water and filtered. The intercalated graphite or oxidized graphite was repeatedly washed in a 5% solution of HCl to remove most of the sulphate ions. The sample was then washed repeatedly with deionized water until the pH of the filtrate was neutral. The slurry was dried and stored in a vacuum oven at 60° C. for 24 hours. The dried powder sample was placed in a quartz tube and inserted into a horizontal tube furnace pre-set at a desired temperature, 1,050° C. for 45 seconds to obtain exfoliated graphite. Isolated NGPs were then obtained via ultrasonication of exfoliated graphite in water, forming a graphene-water suspension.

For the preparation of a SMC, NGPs were used as an intercalation-free cathode active material and an activated soft carbon was used as an intercalation-free anode material. A lithium foil was added between the anode and the separator.

For the preparation of vanadium oxide-based intercalation cathode active material, V₂O₅ (99.6%, Alfa Aesar) and LiOH (99+%, Sigma-Aldrich) were used to prepare the precursor solution. Graphene (1% w/v obtained above) was used as a structure modifier. First, V₂O₅ and LiOH in a stoichiometric V/Li ratio of 1:3 were dissolved in actively stirred de-ionized water at 50° C. until an aqueous solution of LiₓV₃O₈ was formed. Then, graphene-water suspension was added while stirring, and the resulting suspension was atomized and dried in an oven at 160° C. to produce the spherical composite particulates of graphene/LiₓV₃O₈ nano-sheets (graphene-wrapped LiₓV₃O₈ particles). In a conventional lithium metal secondary cell (as a control sample), lithium foil was used as an anode active material and these composite particles were used as a cathode active material.

A super-hybrid cell was made that was formed of an NGP anode (intercalation-free) and a hybrid cathode composed of an intercalation-free NGP layer bonded to one surface of a cathode current collector and a graphene-wrapped LiₓV₃O₈ composite layer bonded to the opposing layer of the cathode current collector.

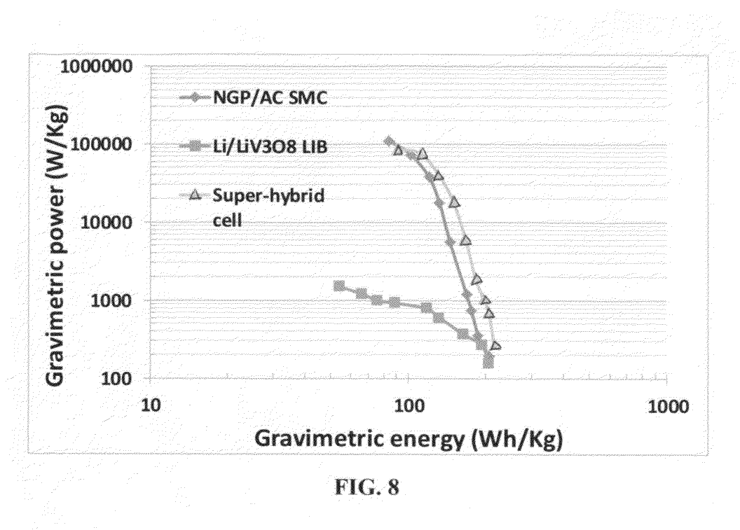

The Ragone plots for these three cells are shown in FIG. 8. Although the energy density of the Li-vanadium oxide cell is relatively high at very low discharge rates (or very low current densities), the power densities are relatively low. Both of the SMC and the super-hybrid cell exhibit significantly higher power densities than those of the corresponding Li-vanadium cell. Quite significantly, the super-hybrid cell (with a LiₓV₃O₈ composite layer/NGP layer ratio of 1/3) exhibits a performance curve essentially above the curve for the corresponding SMC. This is very surprising since the graphene content of the hybrid cell is between that of the Li-vanadium cell and that of the SMC cell. There appears to be a significant synergistic effect exhibited by the super-hybrid cell.

### Example 3

### SMC and Supercapacitor Based on Graphene Anode and Meso-Porous Carbon Cathode in Comparison with a Corresponding Super-Hybrid Cell and a Lithium-Ion Battery

Meso-phase carbon was carbonized at 500° C. for 3 hours and then heat treated at 1500° C. for 4 hours to obtain meso-carbon, which was powderized to obtain meso-carbon particles typically 5-34 μm in size. Meso-carbon particles were mixed with small tablets of KOH (four-fold weight) in an alumina melting pot. Subsequently, the carbon-KOH mixture was heated at 850° C. for 2 h in N₂. Upon cooling, the alkali-rich residual carbon was washed with hot water until the outlet water reached a pH value of 7. The resulting material is activated meso-porous carbon. Four cells were prepared and tested:
(a) a super-hybrid cell containing a graphite/graphene hybrid anode (a layer of natural graphite as an intercalation compound coated on a surface of a porous anode current collector, and a graphene layer coated on this graphite layer, as illustrated in FIG. 3(D)), a separator layer, an intercalation-free meso-porous carbon cathode coated on a cathode current collector (as illustrated in FIG. 3(C)), and a piece of lithium foil as a lithium source implemented on the opposing surface of the anode current collector (as illustrated in FIG. 5(A));
(b) a lithium-ion capacitor cell (LIC) composed of a graphite anode (provided with a Li foil) and a commercially available supercapacitor-grade activated carbon cathode;
(c) a SMC composed of a meso-porous carbon anode provided with a Li foil, a meso-porous carbon cathode; and
(d) a symmetric supercapacitor (meso-porous carbon anode and cathode).

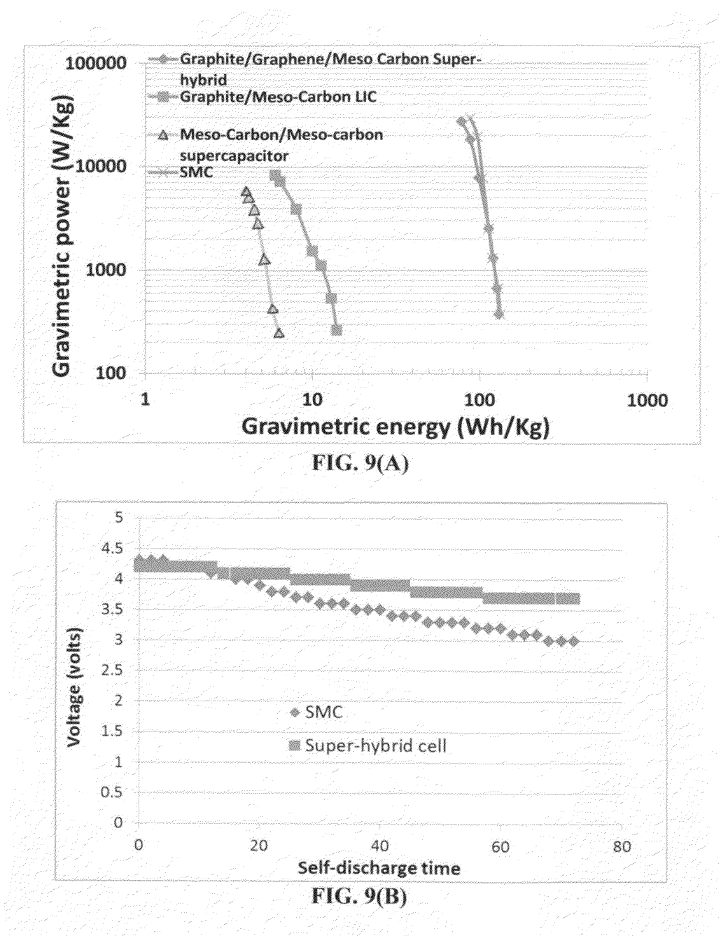

The Ragone plots of these four cells are shown in FIG. 9(A), which indicates that both SMC and the super-hybrid cells are distinct from both a symmetric supercapacitor (EDLC) and a lithium-ion capacitor (LIC). Both the SMC and the super-hybrid cell exhibit dramatically higher energy densities and power densities compared to both capacitor-type devices (EDLC and LIC). This is quite significant and unexpected since the LIC has a graphite anode (intercalation active material), so does the super-hybrid cell. However, the anode in the super-hybrid cell is a hybrid anode having both an intercalation material (graphite) and an intercalation-free material (meso-porous carbon) with a graphite/meso-porous carbon ratio of 0.3/0.7 by weight. The presence of 70% intercalation-free anode active material has dramatically altered the electrochemical behavior.

Also surprisingly, the presence of 30% graphite (intercalation compound) in a hybrid anode of the super-hybrid cell does not have any negative impact on the electrochemical performance. One would expect that the presence of graphite that requires intercalation would slow down the charge-discharge process significantly. Contrary to what one would expect, this did not happen. In addition, as illustrated in FIG. 9(B), the self-discharge rate of the SMC is significantly higher than that of a super-hybrid cell. This was measured by charging the cell to its maximum practical voltage and subsequently monitoring the voltage decay over a period of 72 hours. After 72 hours the SMC experiences a 30% voltage drop, but the super-hybrid cell only a 12% drop. We have turned a drawback (of having a presumably slow, undesirable intercalation compound at the anode) into a significant advantage.

### Example 4

### Li-Sulfur Cell and Super-Hybrid Cell Containing a Hybrid Cathode

For the preparation of a Li—S cell, a cathode film was made by mixing 50% by weight of elemental sulfur, 13% graphene, polyethylene oxide (PEO), and lithium trifluoro-methane-sulfonimide (wherein the concentration of the electrolyte salt to PEO monomer units (CH₂CH₂O) per molecule of salt was 99:1], and 5% 2,5-dimercapto-1,3,4-dithiadiazole in a solution of acetonitrile (the solvent to PEO ratio being 60:1 by weight). The components were stir-mixed for approximately two days until the slurry was well mixed and uniform. A thin cathode film was cast directly onto stainless steel current collectors, and the solvent was allowed to evaporate at ambient temperatures. The resulting graphene-wrapped sulfur particle-based film weighed approximately 0.0030-0.0058 gm/cm².

The polymeric electrolyte separator was made by mixing PEO with lithium trifluoromethanesulfonimide, (the concentration of the electrolyte salt to PEO monomer units (CH₂CH₂O) per molecule of salt being 39:1) in a solution of acetonitrile (the solvent to polyethylene oxide ratio being 15:1 by weight). The components were stir-mixed for two hours until the solution was uniform. Measured amounts of the separator slurry were cast into a retainer onto a release film, and the solvent was allowed to evaporate at ambient temperatures. The resulting electrolyte separator film weighed approximately 0.0146-0.032 gm/cm².

The cathode film and polymeric electrolyte separator were assembled under ambient conditions, and then vacuum dried overnight to remove moisture prior to being transferred into an argon glove box for final cell assembly with a 3 mil (75 micron) thick lithium anode foil. The anode current collector was Cu foil. Once assembled, the cell was compressed at 3 psi and heated at 40° C. for approximately 6 hours to obtain an integral cell structure.

For a super-hybrid cell, a layer of graphene-wrapped sulfur particle film is coated on a surface of a porous cathode current collector and a layer of intercalation-free graphene sheets is coated on the opposing surface.

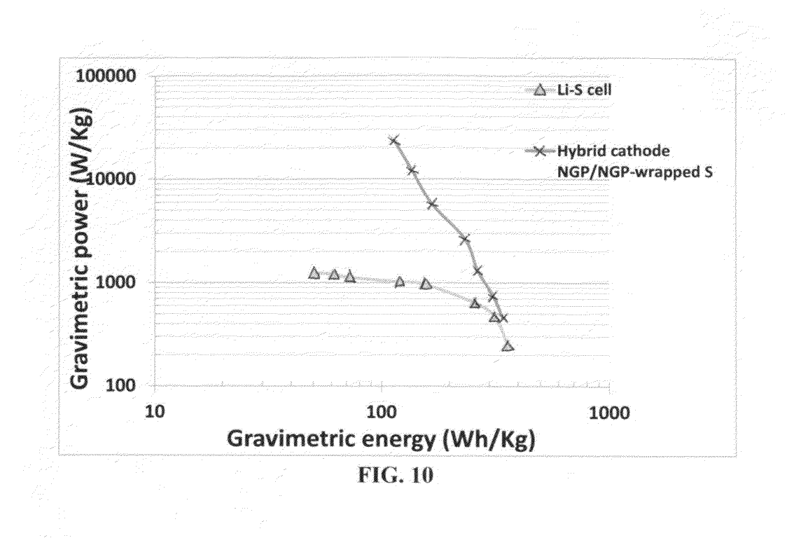

FIG. 10 shows the Ragone plots of the two cells, which indicate that the conventional Li—S cell, having no intercalation-free active material at the cathode, struggles at high discharge rates or high current densities (the left 4 data points), exhibiting very low power densities despite its ability to achieve a maximum energy density higher than 350 Wh/kg. In addition to requiring lithium ions to diffuse into the interior of sulfur particles, it would also take additional time for Li ions to react with S, resulting in very low power densities. This serious problem has been overcome by implementing a layer of graphene-based intercalation-free active material on the front face of the cathode current collector. This intercalation-free material forming a meso-porous structure is directly exposed to electrolyte and capable of rapidly capturing and storing lithium on graphene surfaces. Additional amount of lithium ions is then gradually absorbed by the S layer on the opposite side of the porous current collector. The resulting super-hybrid cell exhibits the best of two worlds: the high energy density of a Li—S cell and a high power density of a SMC. This has never been observed with any conventional supercapacitor, lithium ion capacitor, lithium-ion battery, lithium-sulfur cell, Lithium-air cell (very poor power density), lithium metal secondary battery, or SMC. No electrochemical cell of any type has been able to achieve an energy density of >300 Wh/kg (based on total cell weight) and also a power density of nearly 30 kW/kg (based on total cell weight).

A super-hybrid energy storage device may be internally connected to an electrochemical energy storage device in series or in parallel, wherein the electrochemical energy storage device may be selected from a supercapacitor, lithium-ion capacitor, lithium-ion battery, lithium metal secondary battery, lithium-sulfur cell, surface-mediated cell, or super-hybrid cell. Alternatively, the super-hybrid energy storage device may be internally connected in series or in parallel to an intercalation or intercalation-free electrode of an electrochemical energy storage device, selected from a supercapacitor, lithium-ion capacitor, lithium-ion battery, lithium metal secondary battery, lithium-sulfur cell, surface-mediated cell, or super-hybrid cell.

The internal parallel connection of multiple cells, including at least a super-hybrid cell, to form a stack provides several unexpected advantages over individual cells that are externally connected in parallel:
(1) The internal parallel connection strategy reduces or eliminates the need to have connecting wires (individual anode tabs being welded together and, separately, individual cathode tabs being welded together), thereby reducing the internal and external resistance of the cell module.
(2) In an external connection scenario, each and every SMC or super-hybrid cell must have a lithium source (e.g. a piece of lithium foil). Three cells will require three pieces of lithium foils, for instance. This amount is redundant and adds not only additional costs, but also additional weight and volume to a battery pack.
(3) Since only one lithium source is needed in a stack of more than one SMC or super-hybrid cells internally connected in parallel, the production configuration is less complex.
(4) The internal parallel connection strategy removes the need to have a protective circuit for every individual cell (in contrast to an externally connected configuration that requires 3 protective circuits for 3 cells, for instance). The internal parallel connection is surprisingly capable of imparting self-adjusting capability to a stack and each stack needs at most only one protective circuit.
(5) The internal parallel connection strategy enables a stack to achieve a significantly higher power density than what can be achieved by an externally connected pack given an equal number of cells.

The internal parallel connection of multiple cells, including at least a super-hybrid cell, to form a stack has a characteristic that the electrolyte in one cell does not communicate with the electrolyte in another cell. The two cells are electronically connected through a common current collector that is non-porous and non-permeable to liquid electrolyte. The presently invented internal series connection technology has the following additional features and advantages:
(6) Any output voltage (V) and capacitance value (Farad, F) can be tailor-made;
(7) The output voltage (Vₕ) per super-hybrid cell unit can be as high as 4.5 volts and, hence, the output voltage of a super-hybrid cell internally series-connected to an electrochemical cell (having an operating voltage of Vₑ) can be (Vₕ+Vₑ). Assume that all the constituent cells are either a super-hybrid cell or an SMC, the stack can be a multiple of 4.5 volts (4.5, 9.0, 13.5, 18, 22.5, 27, 31.5, 36 volts, etc.). We can achieve 36 volts with only 8 unit cells connected in series. In contrast, with a unit cell voltage of 2.5 volts for a symmetric supercapacitor, it would take 15 cells to reach 36 volts. With a unit cell voltage of 3.5 volts for a lithium-ion battery cell, it would take 11 cells connected in series. Further, the stack of LIBs cannot be charged or discharged at a high rate and its power density is very poor. The presence of an intercalation-free electrode active material enables fast charge/discharge rates and high power density values.
(8) During re-charge, each constituent cell can adjust itself to attain voltage distribution equilibrium, removing the need for the high-voltage stack to have a protective circuit.

In conclusion, the instant invention provides a revolutionary energy storage device that has exceeded the best features of a supercapacitor, a lithium ion battery, a lithium metal rechargeable battery, a Li—S cell, and/or an SMC. The super-hybrid cells are capable of storing an energy density of >300 Wh/kg_{cell}, which is 60 times higher than that of conventional electric double layer (EDL) supercapacitors. The power density of typically 20-100 kW/kg_{cell} is 20-100 times higher than that (1 kW/kg_{cell}) of conventional lithium-ion batteries. These super-hybrid cells can be re-charged in minutes, as opposed to hours for conventional lithium ion batteries. This is truly a major breakthrough and revolutionary technology.

We claim:

1. A multi-component hybrid electrode for use in an electrochemical super-hybrid energy storage device, said hybrid electrode containing at least a current collector, at least an intercalation electrode active material storing lithium inside interior or bulk thereof, and at least an intercalation-free electrode active material having a specific surface area no less than 100 m²/g and storing lithium on a surface thereof, wherein the intercalation electrode active material and the intercalation-free electrode active material are in electronic contact with said current collector.

2. The multi-component hybrid electrode of claim 1, wherein said intercalation electrode active material and said intercalation-free electrode active material form two separate discrete layers that are either (a) respectively bonded to two opposing surfaces of said current collector to form a laminated three-layer electrode or (b) stacked together having one layer bonded to a surface of said current collector to form a laminated electrode.

3. The multi-component hybrid electrode of claim 2, wherein said current collector is porous to enable passage of lithium ions.

4. The multi-component hybrid electrode of claim 1, wherein said intercalation electrode active material and said intercalation-free electrode active material are mixed to form a hybrid active material coated onto one surface or two opposing surfaces of said current collector.

5. The multi-component hybrid electrode of claim 4, wherein said current collector is porous to facilitate lithium ion passage.

6. The multi-component hybrid electrode of claim 1, having at least two current collectors internally connected in parallel, wherein said intercalation electrode active material is coated on at least a surface of a first current collector and said intercalation-free electrode active material is coated on at least a surface of a second current collector.

7. The multi-component hybrid electrode of claim 1, wherein said hybrid electrode is pre-lithiated, having lithium inserted into interior of said intercalation electrode active material and/or having lithium deposited on a surface of said intercalation-free electrode active material.

8. The multi-component hybrid electrode of claim 1, wherein said intercalation electrode active material has a specific surface area less than 100 m²/g.

9. The multi-component hybrid electrode of claim 1, wherein said intercalation electrode active material has a specific surface area less than 100 m²/g and said intercalation-free electrode active material has a specific surface area no less than 500 m²/g.

10. The multi-component hybrid electrode of claim 1, wherein said intercalation electrode active material has a specific surface area less than 50 m²/g and said intercalation-free electrode active material has a specific surface area no less than 1,500 m²/g.

11. The multi-component hybrid electrode of claim 1, wherein said intercalation material is an anode active material selected from the following:
(h) a graphite or carbonaceous intercalation compound having a specific surface area less than 100 m²/g when formed into an anode, said intercalation compound is selected from natural graphite, synthetic graphite, meso-phase carbon, soft carbon, hard carbon, amorphous carbon, polymeric carbon, coke, meso-porous carbon, carbon fiber, graphite fiber, carbon nano-fiber, carbon nano-tube, and expanded graphite platelets or nano graphene platelets containing multiple graphene planes bonded together;
(a) silicon (Si), germanium (Ge), tin (Sn), lead (Pb), antimony (Sb), bismuth (Bi), zinc (Zn), aluminum (Al), titanium (Ti), and cadmium (Cd);
(b) alloys or intermetallic compounds of Si, Ge, Sn, Pb, Sb, Bi, Zn, Al, Ti, or Cd with other elements, wherein said alloys or compounds are stoichiometric or non-stoichiometric;
(c) oxides, carbides, nitrides, sulfides, phosphides, selenides, and tellurides of Si, Ge, Sn, Pb, Sb, Bi, Zn, Al, Ti, Ni, Co, Mn, Fe, or Cd, and their mixtures, composites, or lithium-containing composites, including Co₃O₄, Mn₃O₄, and their mixtures or composites;
(d) salts and hydroxides of Sn;
(e) lithium titanate, lithium manganate, lithium aluminate, lithium-containing titanium oxide, lithium transition metal oxide; or
(f) a combination thereof.

12. The multi-component hybrid electrode of claim 1, wherein said intercalation material is a cathode active material capable of storing lithium in interior or bulk of said material, selected from the group consisting of lithium cobalt oxide, cobalt oxide, lithium nickel oxide, nickel oxide, lithium manganese oxide, vanadium oxide V₂O₅, V₃O₈, lithium transition metal oxide, lithiated oxide of transition metal mixture, non-lithiated oxide of a transition metal, non-lithiated oxide of transition metal mixture, lithium iron phosphate, lithium vanadium phosphate, lithium manganese phosphate, a non-lithiated transition metal phosphate, a chalcogen compound, sulfur, sulfur-containing molecule, sulfur-containing compound, sulfur-carbon polymer, sulfur dioxide, thionyl chloride (SOCl₂), oxychloride, manganese dioxide, carbon monofluoride ((CF)ₙ), iron disulfide, copper oxide, lithium copper oxyphosphate (Cu₄O(PO₄)₂), silver vanadium oxide, MoS₂, TiS₂, NbSe₃, and combinations thereof.

13. The multi-component hybrid electrode of claim 12, wherein said intercalation material is in a form of nano-scaled particle, wire, rod, tube, ribbon, sheet, film, or coating having a dimension less than 100 nm.

14. The multi-component hybrid electrode of claim 12, wherein said intercalation material is in a form of nano-scaled particle, wire, rod, tube, ribbon, sheet, film, or coating having a dimension less than 20 nm.

15. The multi-component hybrid electrode of claim 1, wherein said intercalation-free electrode material is a cathode active material that forms a porous structure having a specific surface area no less than 100 m²/g and is selected from:
(a) a porous disordered carbon material selected from activated soft carbon, activated hard carbon, activated polymeric carbon or carbonized resin, activated meso-phase carbon, activated coke, activated carbonized pitch, activated carbon black, activated carbon, or activated partially graphitized carbon;
(b) a graphene material selected from a single-layer graphene, multi-layer graphene, graphene oxide, graphene fluoride, hydrogenated graphene, nitrogenated graphene, boron-doped graphene, nitrogen-doped graphene, functionalized graphene, or reduced graphene oxide;
(c) a meso-porous exfoliated graphite;
(d) a meso-porous carbon;
(e) a carbon nanotube (CNT) selected from a single-walled carbon nanotube or multi-walled carbon nanotube, oxidized CNT, fluorinated CNT, hydrogenated CNT, nitrogenated CNT, boron-doped CNT, nitrogen-doped CNT, or doped CNT;
(f) a carbon nano-fiber, or
(g) a combination thereof.

16. The multi-component hybrid electrode of claim 1, wherein said intercalation-free electrode material is an anode active material that forms a porous structure having a specific surface area no less than 100 m²/g and is selected from:
(a) a porous disordered carbon material selected from activated soft carbon, activated hard carbon, activated polymeric carbon or carbonized resin, activated meso-phase carbon, activated coke, activated carbonized pitch, activated carbon black, activated carbon, or activated partially graphitized carbon;
(b) a graphene material selected from a single-layer graphene, multi-layer graphene, graphene oxide, graphene fluoride, hydrogenated graphene, nitrogenated graphene, boron-doped graphene, nitrogen-doped graphene, functionalized graphene, or reduced graphene oxide;
(c) a meso-porous exfoliated graphite;
(d) a meso-porous carbon;
(e) a carbon nanotube selected from a single-walled carbon nanotube or multi-walled carbon nanotube;
(f) a carbon nano-fiber, or
(g) a combination thereof.

17. A super-hybrid energy storage device comprising a hybrid electrode of claim 1 as a first electrode, a second electrode, a separator disposed between said first and second electrodes, and electrolyte in ionic contact with said electrodes, wherein at least one of said electrodes is provided with a lithium source or pre-loaded with lithium.

18. The super-hybrid energy storage device claim 17, wherein said hybrid electrode is an anode and said second electrode is a cathode formed of a porous cathode active material having a specific surface area no less than 100 m²/g in direct contact with electrolyte, wherein said device operates on an exchange of lithium ions between a surface and/or interior of an anode active material and a surface of said cathode active material.

19. A super-hybrid energy storage device of claim 17, wherein said hybrid electrode is a cathode and said device operates on an exchange of lithium ions between a surface and/or interior of a cathode active material and a surface of said anode.

20. A super-hybrid energy storage device of claim 17, wherein said second electrode is an anode having a current collector and an anode active material and said hybrid electrode is a cathode, and wherein said device operates on an exchange of lithium ions between a surface and/or interior of a cathode active material and a surface of said anode current collector or a surface or interior of said anode active material.

21. A super-hybrid energy storage device of claim 17, wherein said first electrode is a hybrid anode, and said second electrode is a hybrid cathode, wherein said device operates on an exchange of lithium ions between a surface and/or interior of a cathode active material and a surface and/or interior of an anode active material.

22. A super-hybrid energy storage device, comprising:
(A) a first anode being formed of a first anode current collector having a surface area to capture or store lithium thereon;
(B) a first hybrid electrode of claim 1 as a cathode comprising a first cathode current collector and a first intercalation-free cathode active material coated on at least a surface of said first cathode current collector, and a first interaction cathode active material coated on a surface of a second cathode current collector, wherein said first and second cathode current collectors are internally connected in parallel;
(C) a first porous separator disposed between the first hybrid cathode and the first anode;
(D) a lithium-containing electrolyte in physical contact with said first hybrid cathode and first anode; and
(E) at least a lithium source implemented at or near at least one of the anodes or cathodes prior to a first charge or a first discharge cycle of the energy storage device;
wherein said first intercalation-free cathode active material has a specific surface area of no less than 100 m²/g being in direct physical contact with said electrolyte to receive lithium ions therefrom or to provide lithium ions thereto.

23. A super-hybrid energy storage device containing a hybrid electrode of claim 6 as an anode or cathode, at least a counter electrode, a separator separating an anode from a cathode, electrolyte in ionic contact with all electrodes, and a lithium source disposed at an electrode.

24. The super-hybrid energy storage device of claim 22, further comprising a second anode being formed of a second anode current collector having a surface area to capture or store lithium thereon.

25. The super-hybrid energy storage device of claim 22, wherein said first anode contains an anode active material having a specific surface area greater than 100 m²/g.

26. The super-hybrid energy storage device of claim 24, wherein said first anode current collector and said second anode current collector are connected to an anode terminal, and said first cathode current collector and said second cathode current collector are connected to a cathode terminal.

27. The super-hybrid energy storage device of claim 22, wherein at least one of the anode current collectors or cathode current collectors is a porous, electrically conductive material selected from metal foam, metal web or screen, perforated metal sheet, metal fiber mat, metal nanowire mat, porous conductive polymer film, conductive polymer nano-fiber mat or paper, conductive polymer foam, carbon foam, carbon aerogel, carbon xerox gel, graphene foam, graphene oxide foam, reduced graphene oxide foam, carbon fiber paper, graphene paper, graphene oxide paper, reduced graphene oxide paper, carbon nano-fiber paper, carbon nano-tube paper, or a combination thereof.

28. The super-hybrid energy storage device of claim 17, wherein the lithium source comprises a lithium chip, lithium foil, lithium powder, surface stabilized lithium particles, lithium film coated on a surface of an anode or cathode current collector, lithium film coated on a surface of a cathode active material, or a combination thereof.

29. The super-hybrid energy storage device of claim 17, wherein a charge or discharge operation of said device involves both lithium intercalation and lithium deposition on an electrode surface.

30. The super-hybrid energy storage device of claim 17, wherein the electrolyte is liquid electrolyte or gel electrolyte containing a first amount of lithium ions dissolved therein.

31. The super-hybrid energy storage device of claim 30, wherein an operation of said device involves an exchange of a second amount of lithium ions between a cathode and an anode, and said second amount of lithium is greater than said first amount.

32. The super-hybrid energy storage device of claim 17, wherein said lithium source is selected from lithium metal, a lithium metal alloy, a mixture of lithium metal or lithium alloy with a lithium intercalation compound, a lithiated compound, or a combination thereof.

33. The super-hybrid energy storage device of claim 17 wherein said electrolyte comprises a lithium salt-doped ionic liquid, a liquid organic solvent, or a gel electrolyte.

34. The super-hybrid energy storage device of claim 17, which is internally connected to an electrochemical energy storage device in parallel, wherein said electrochemical energy storage device is selected from a supercapacitor, a lithium-ion capacitor, a lithium-ion battery, a lithium metal secondary battery, a lithium-sulfur cell, a surface-mediated cell, or a super-hybrid cell, and wherein an anode of said super-hybrid cell and an anode of said electrochemical cell are internally connected in parallel and a cathode of said super-hybrid cell and a cathode of said electrochemical cell are internally connected in parallel.

35. The super-hybrid energy storage device of claim 17, which is internally connected to an electrochemical energy storage device in series, wherein said electrochemical energy storage device is selected from a supercapacitor, lithium-ion capacitor, lithium-ion battery, lithium metal secondary battery, lithium-sulfur cell, surface-mediated cell, or super-hybrid cell and wherein electrolyte of said super-hybrid cell is not in fluid communication with electrolyte of said electrochemical cell.

36. The super-hybrid energy storage device of claim 17, which is internally connected in series or in parallel to an intercalation or intercalation-free electrode of an electrochemical energy storage device, selected from a supercapacitor, lithium-ion capacitor, lithium-ion battery, lithium metal secondary battery, lithium-sulfur cell, surface-mediated cell, or super-hybrid cell.
